(19) United States
(12) Patent Application Publication
(10) Pub. No.: US 2022/0374449 A1
(43) Pub. Date: Nov. 24, 2022

(54) SYSTEM AND METHOD FOR PRODUCTIONIZING UNSTRUCTURED DATA FOR ARTIFICIAL INTELLIGENCE (AI) AND ANALYTICS

(71) Applicant: Labelbox, Inc., San Francisco, CA (US)

(72) Inventors: Nick A. Lee, Burlingame, CA (US); Christopher J. Amata, San Francisco, CA (US); John T. Vega, Camarillo, CA (US)

(21) Appl. No.: 17/750,372

(22) Filed: May 22, 2022

Related U.S. Application Data
(60) Provisional application No. 63/191,989, filed on May 22, 2021.

(51) Int. Cl. G06F 16/25; G06F 16/22; G06K 9/62

(52) U.S. Cl. CPC G06F 16/258; G06F 16/252; G06F 16/221; G06K 9/6259

(57) ABSTRACT

The solution enables a data block composed of unstructured data assets (e.g., a Spark Dataframe) in a compute and analytics environment (e.g., Databricks) to be sent to a Training Data Platform (e.g., Labelbox, Inc.) for labeling. Then, the annotated structured dataset can be loaded back as a structured data asset (e.g., a Spark Dataframe) in the compute and analytics environment (e.g., Databricks). The solution provides an interface between a compute and analytics environment like Databricks and a Training Data Platform like Labelbox. The solution provides a Python library which facilitates data flow between the compute and analytics environment (e.g. Databricks) and the Training Data Platform (e.g., Labelbox). The library provides methods that help process the JSON annotations coming back from the training data platform. The solution facilitates the ability to train machine learning models, to structure unstructured datasets, and perform a model assisted labeling workflow from the compute and analytics environment.

### PRIORITY PATENT APPLICATION

This non-provisional patent application draws priority from U.S. provisional patent application Ser. No. 63/191,989; filed May 22, 2021. The entire disclosure of the referenced patent application is considered part of the disclosure of the present application and is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2019-2022, Labelbox, Inc., All Rights Reserved.

### TECHNICAL FIELD

This patent document pertains generally to data processing, machine learning and artificial intelligence (AI) systems, content annotation, data communication networks, and more particularly, but not by way of limitation, to a system and method for productionizing unstructured data for artificial intelligence (AI) and analytics.

### BACKGROUND

Many businesses possess a vast treasure trove of data, except this data is unstructured. This data is a trove of images, video, text, all of it about important things going on in the business. The problem is that when you take this data in its current state unless the data is properly formatted so that a data algorithm can understand it, the only thing you get is a confused algorithm. Companies can benefit from productionizing this unstructured data for AI and analytics so that they can derive valuable insight from that data and train AI and machine learning (ML), to provide recommendations and predictions based on that data.

The benefits are huge. For example, if we can tackle this problem, we can build security cameras that recognize crime or create software that can help doctors identify cancer or other problems in a medical scan. We can reduce manufacturing defects by catching product flaws as they move across the conveyor belt at thousands of products per minute. If this problem can be solved at scale and efficiently, we have a potential to really change a lot of things in today's society.

### SUMMARY

The solution disclosed herein enables a data block composed of unstructured data assets (e.g., a Spark Dataframe) in a compute and analytics environment (e.g., Databricks) to be sent to a Training Data Platform (e.g., Labelbox, Inc.) for labeling. Then, the annotated structured dataset can be loaded back as a structured data asset (e.g., a Spark Dataframe) in the compute and analytics environment (e.g., Databricks). The solution provides an interface between a compute and analytics environment like Databricks and a Training Data Platform like Labelbox. The solution provides a Python library which facilitates data flow between the compute and analytics environment (e.g. Databricks) and the Training Data Platform (e.g., Labelbox). The library provides methods that help process the JSON annotations coming back from the training data platform. The solution facilitates the ability to train machine learning models, to structure unstructured datasets, and perform a model assisted labeling workflow from the compute and analytics environment.

### BRIEF DESCRIPTION OF THE DRAWINGS

The various embodiments are illustrated by way of example, and not by way of limitation, in the figures of the accompanying drawings in which:

FIGS. 1 through 45 illustrate example embodiments of the system and method for productionizing unstructured data for AI and analytics as disclosed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

A system and method for productionizing unstructured data for AI and analytics are disclosed herein. In the various example embodiments disclosed herein, the solution can take unstructured data and productionize that data for machine learning and analytical workflows at scale. The solution enables a data block composed of unstructured data assets (e.g., a Spark Dataframe) in a compute and analytics environment (e.g., Databricks) to be sent to a Training Data Platform (e.g., Labelbox, Inc.) for labeling. Then, the annotated structured dataset can be loaded back as a structured data asset (e.g., a Spark Dataframe) in the compute and analytics environment (e.g., Databricks). The solution provides an interface between a compute and analytics environment like Databricks and a Training Data Platform like Labelbox. The solution provides a Python library which facilitates data flow between the compute and analytics environment (e.g. Databricks) and the Training Data Platform (e.g., Labelbox). The library provides methods that help process the JSON annotations coming back from the training data platform. The solution facilitates the ability to train machine learning models, to structure unstructured datasets, and perform a model assisted labeling workflow from the compute and analytics environment.

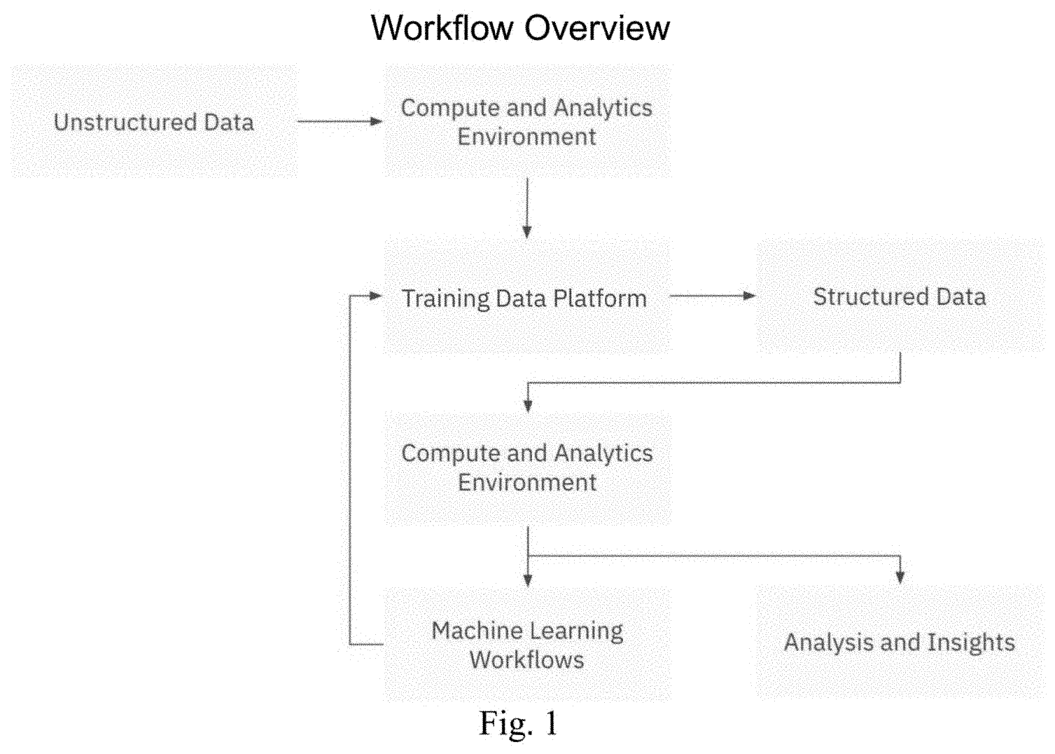

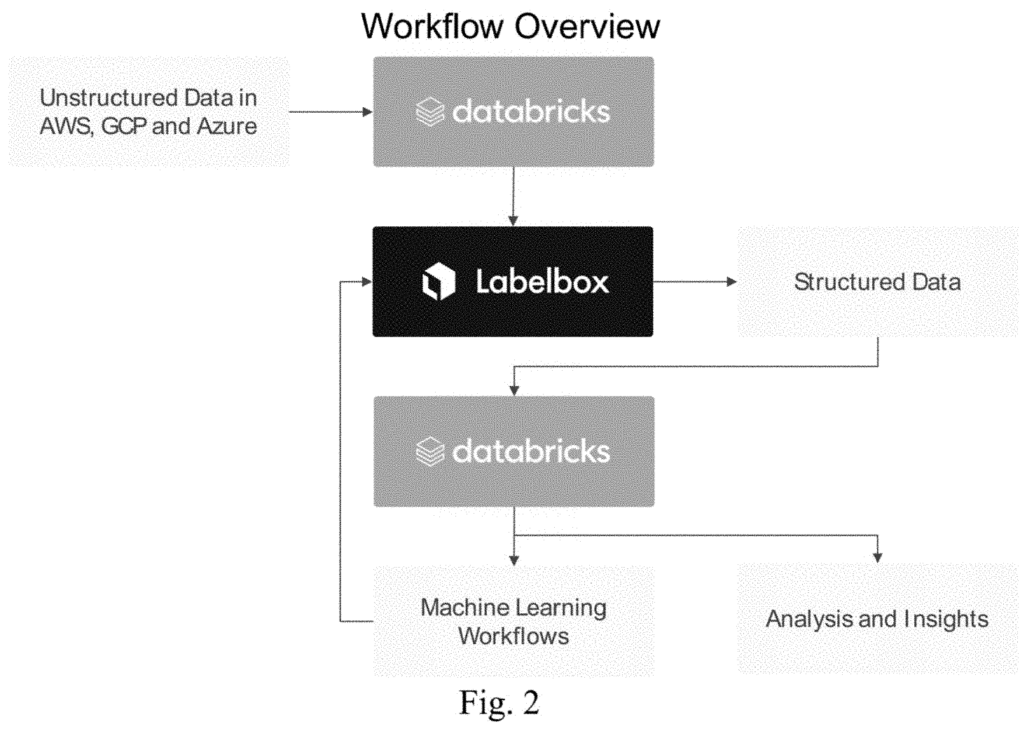

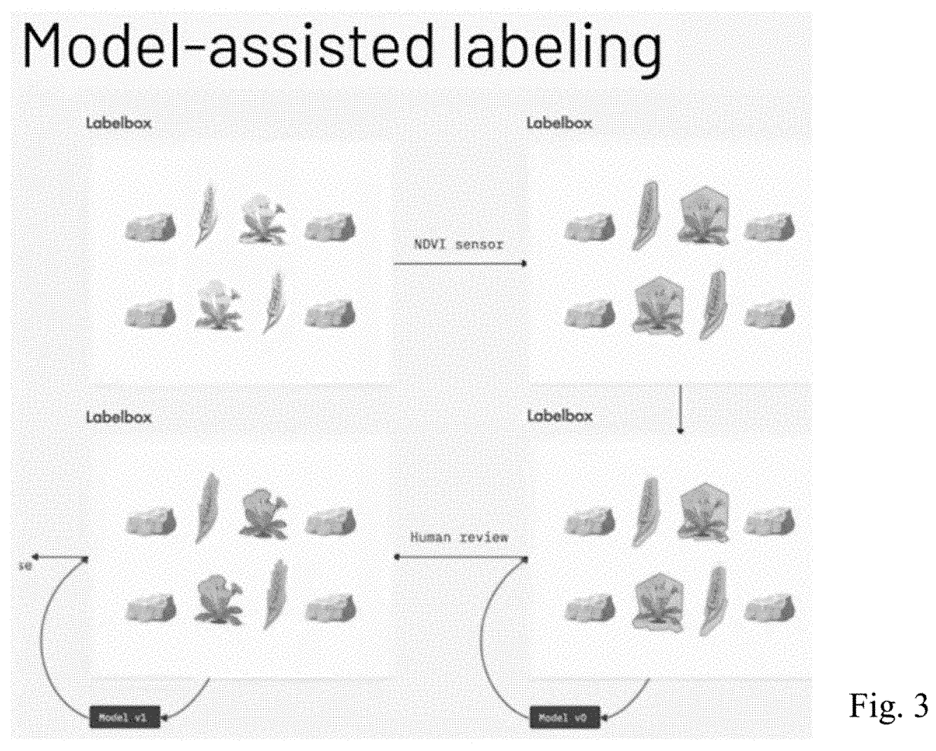

Referring to FIGS. 1 through 3, a Training Data Platform (e.g., Labelbox, Inc.) can be configured to take unstructured data residing in the cloud, maybe that's AWS or GCP or Azure, or any other source or repository for unstructured data. Then, within their compute and analytics environment, a data team can take that unstructured data and pass it to a training data platform where a team of labelers and subject matter experts can add structure and enrich the data with annotations. From there, the structured data returns to the compute and analytics environment and the team is able to run the structured data though machine learning (ML) or pass it along to a team of analysts for insights and analysis. More advanced companies are able to take their machine learning algorithms and apply them to the new data as it comes in to pre-label data going into the training data platform, as well as, provide opportunities for the human labeler to audit that algorithm and see how their labeling data process performs. If a human can inspect the algorithm's output, they can correct it and retrain the algorithm on it to get an improved algorithm. An example embodiment disclosed herein provides an example using a compute and analytics environment like Databricks and a Training Data Platform like Labelbox, Inc.

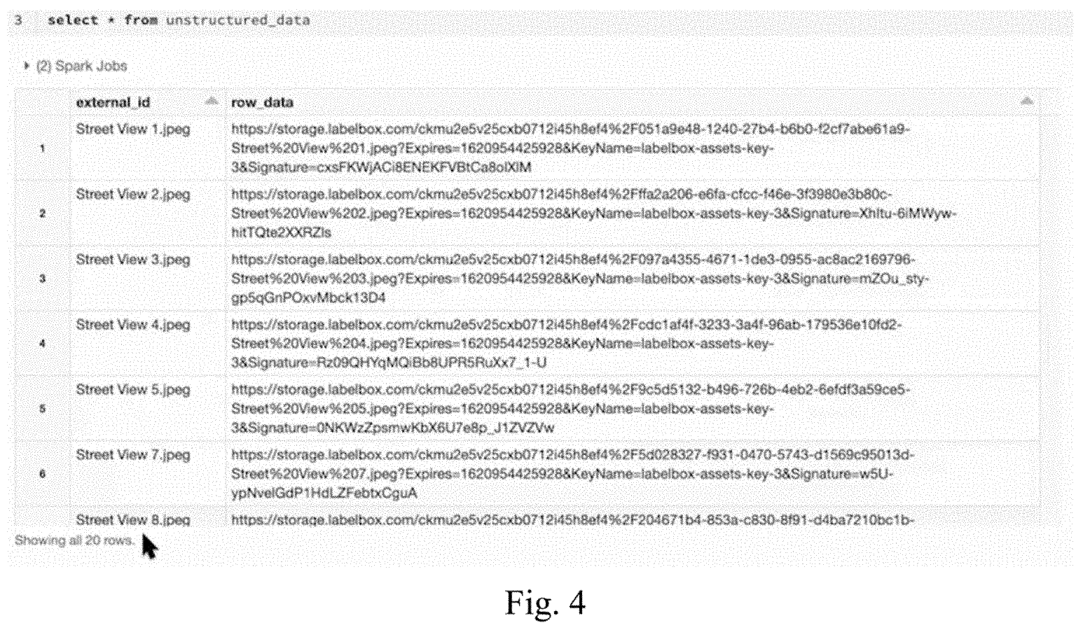

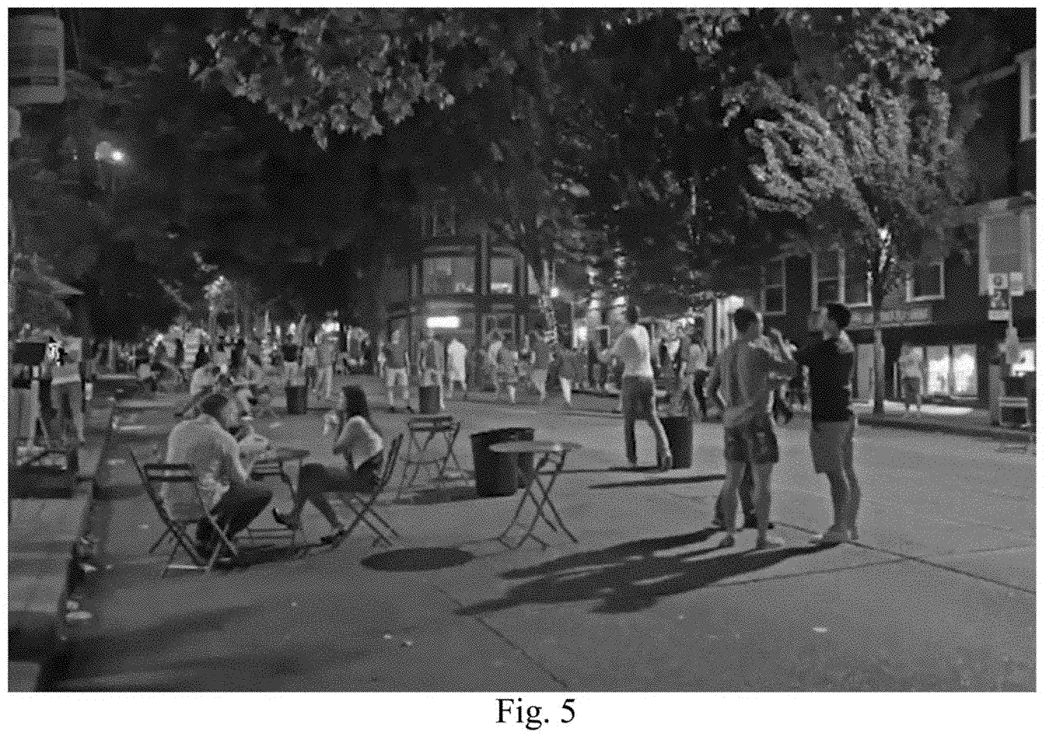

Referring to FIG. 4, in the disclosed example, a user can log into the compute and analytics environment (e.g., Databricks). For this example, a sample table called ‘unstructured data’ is loaded. In this example, it's a very simple data set. The sample table has only 20 rows for illustrative purposes. The sample table is a bunch of photos from cameras on a street. See a visualization of the example in FIG. 5. The example data set is just photos of people out and about in an urban environment.

Using the tools disclosed herein, we build a model that can recognize the people in the frame, as well as other objects in the image, such as umbrellas and cars, if there are any cars in the image. This is just an example. Your use case could be in manufacturing or medicine. The data in the image is unstructured, and it can be in a Spark table.

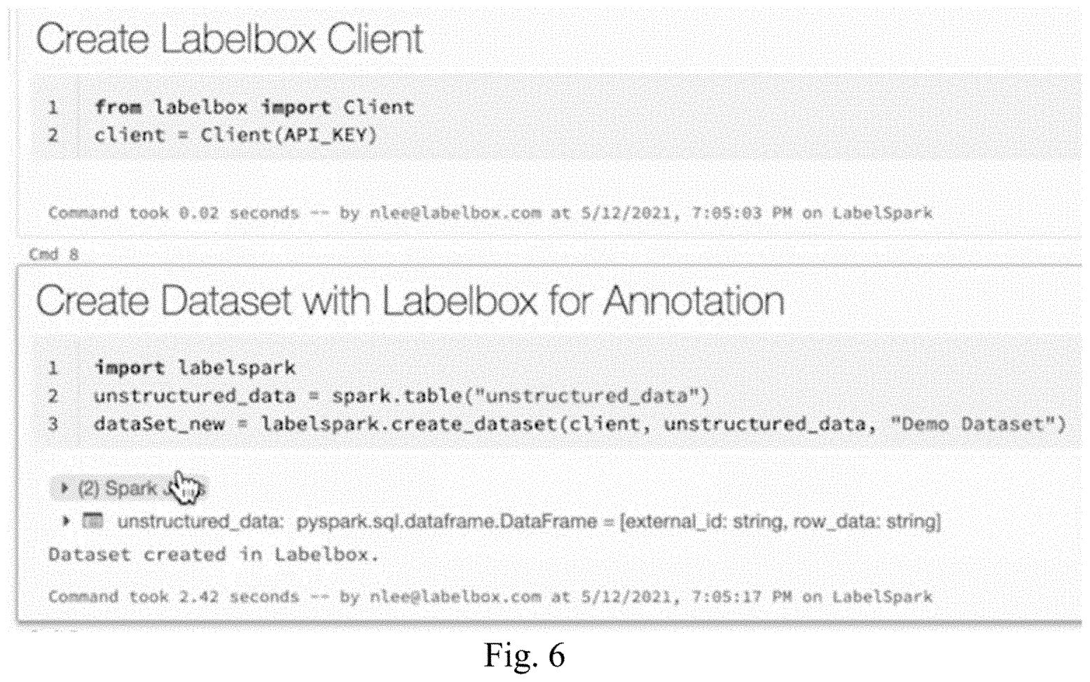

Referring to FIG. 6, we can create a Training Data Platform (e.g., Labelbox, Inc.) client with a label spark library having the sample ‘unstructured data’ table as described above. We can pass the unstructured data spark table corresponding to the sample image right to the Training Data Platform (e.g., Labelbox, Inc.). The command can be called with just a few lines of code that can register that data set in Training Data Platform (e.g., Labelbox, Inc.). Note that the data has not actually been uploaded to the Training Data Platform (e.g., Labelbox, Inc.). The data still resides in the compute and analytics environment. In fact, the Training Data Platform (e.g., Labelbox, Inc.) doesn't need to have a local copy of the data. The Training Data Platform can just reference the information in the compute and analytics environment. There is no need to move it.

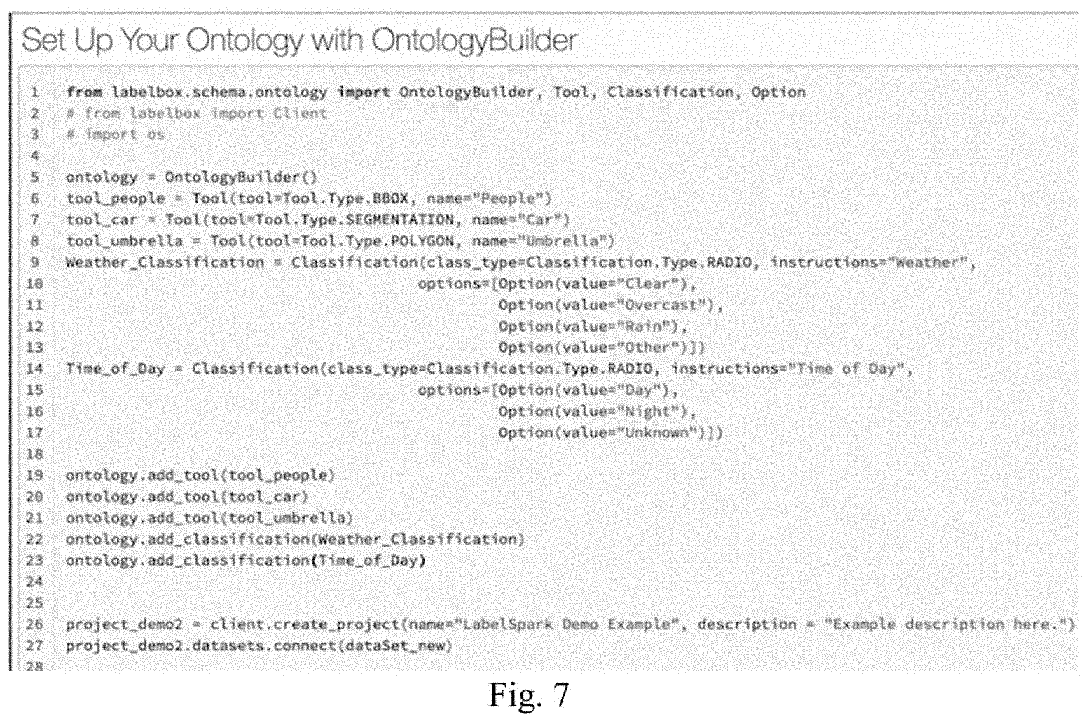

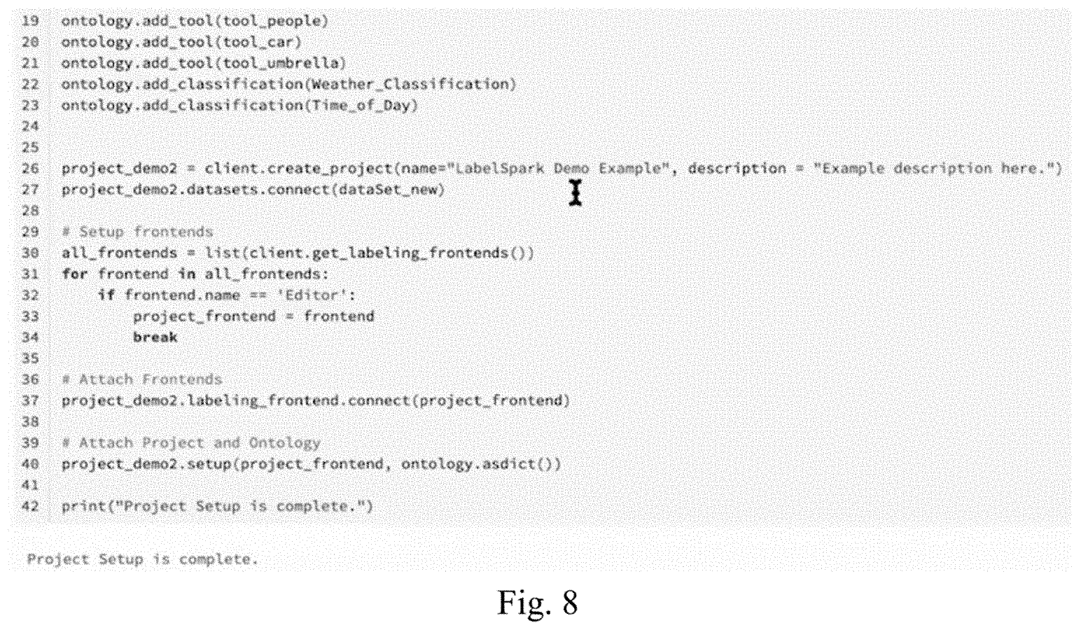

Referring to FIGS. 7 and 8, within the Training Data Platform (e.g., Labelbox, Inc.), we have an ontology builder that allows a user to programmatically set up the ontology for the unstructured data set. The ontology can be a set of questions asked of the labeler about this image or video or text. So, in this example, we have added a bounding box tool that I want the labeler to use to select all the people (or other object type) in the frame. I've included a segmentation mask tool, so labelers can draw over all of the cars and identify the cars that way. I've added a polygon tool to select all of the umbrellas (or other object type) in the image. In addition, I've included a couple of classification questions. For example, I would like the labeler to identify the weather (or other classification type) in the image, as well as the time of day, if possible. So, creating my ontology and adding tools and classifications, I can complete this ontology and attach it to my project. As a result, the data set and the ontology have programmatically been set up in Training Data Platform (e.g., Labelbox, Inc.).

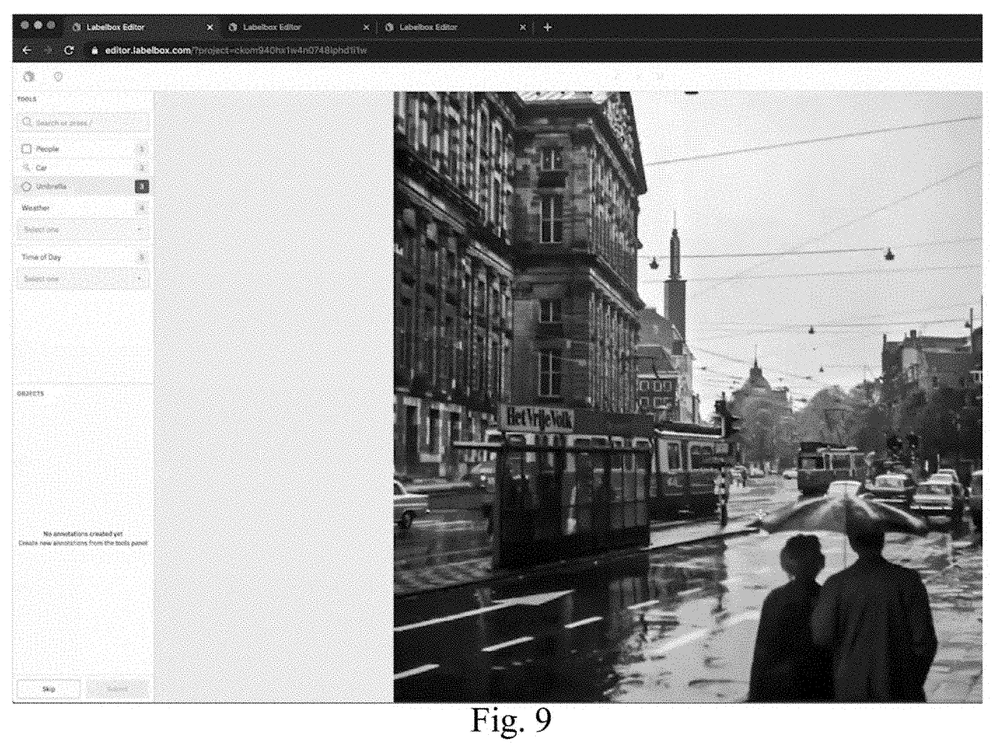

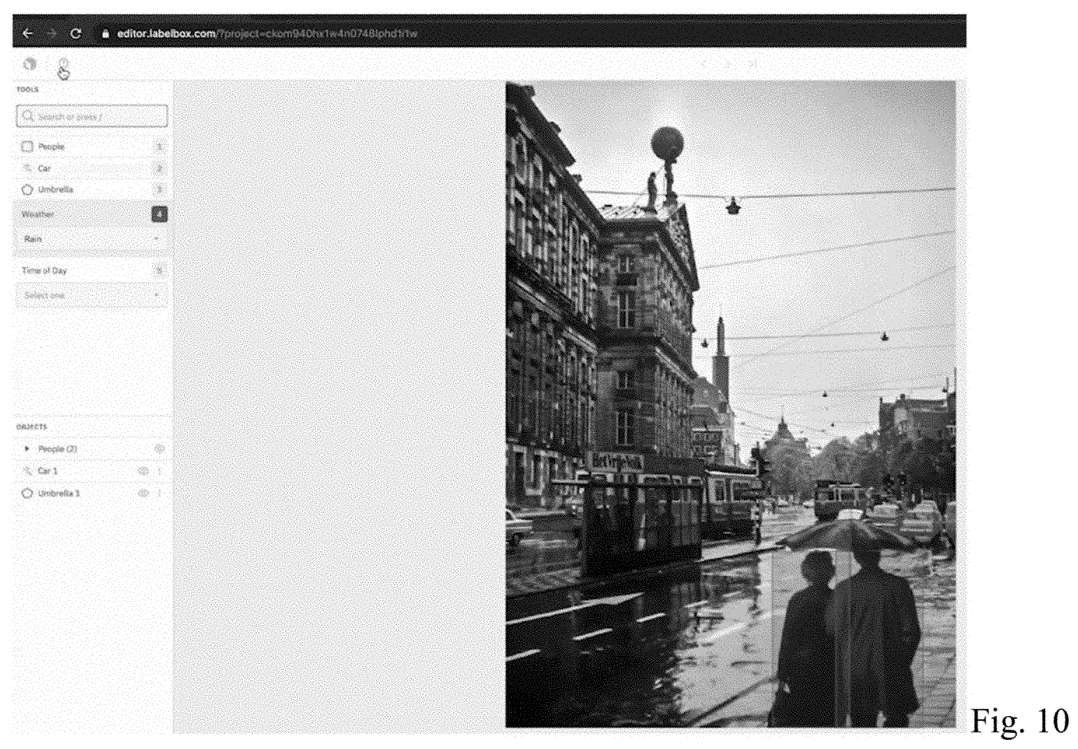

Referring to FIGS. 9 and 10, the created ontology can be used by a labeler to label a sample image. In the example shown in FIGS. 9 and 10, the labeler can label the umbrella with the polygon tool. Additionally, the labeler can use a tool to add a bounding box and start labeling people in the image. In the example shown in FIGS. 9 and 10, the labeler has labeled the umbrella and both of the people in the image. The Training Data Platform (e.g., Labelbox, Inc.) can also provide tools for segmenting the image. The labeler can use the segmentation tool to zoom into the cars (or other object type) in the image. The labeler can also use a freehand tool to point and click just like the polygon tool. The labeler can also use a super pixel tool to label the cars more quickly. The labeler can also use an eraser tool to edit the segmentation masks around all the cars. The labeler can also use a pen tool to fill in portions of the image. Once the labeler has labeled everything, the labeler can start classifying the image, For example, the labeler can look at the weather in the image and determine it is a little rainy; because, the people have the umbrella and there's some water on the ground in the image. Once the labeler submits the labeled or annotated image, the labeler will be sent a brand new image or other data asset right away and the labeler can go in and do the same thing we just described, such as drawing the bounding box around the people, drawing segmentation masks around some of the cars, etc. The labeler can classify many types of objects in the image and do all this different labeling with the imagery. Also, if we're thinking about all different data types that we want to bring in, to put some structure to the image, we can look at different videos and review the way the unstructured data moves in the frames and how the labeling can be adjusted and changed throughout the video.

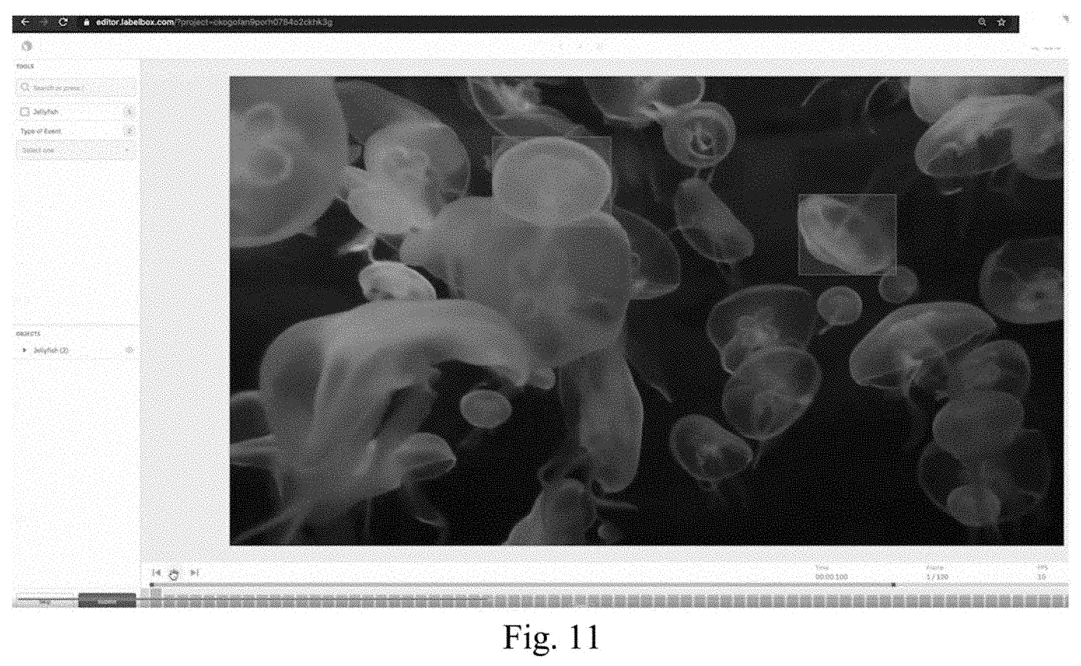

Referring to FIG. 11, within Training Data Platform (e.g., Labelbox, Inc.), we can go in and we can interpolate over all these frames of a video. FIG. 11 shows an example with a couple of bounding boxes drawn on a few jellyfish in a sample video frame. These jellyfish move fluidly in the video and the bounding boxes are chasing them. The labeler can make adjustments to the bounding boxes as needed.

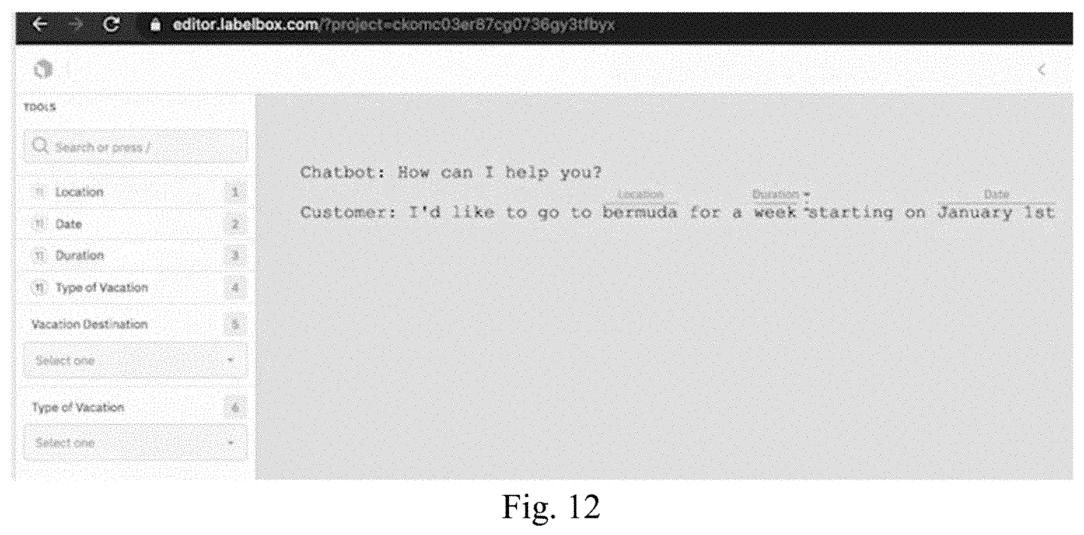

Referring to FIG. 12, we also know that there's a lot of unstructured texts floating around the world. We're going to look at some vacation chatbot texts, for example, to illustrate the text tools of the Training Data Platform (e.g., Labelbox, Inc.). The text tools enable a labeler to classify this text and to add context to the text, chats, messages, and any text that is in PDFs, for example. In the example, the location, duration, and date portions of the text can be labeled. Other labels and context can be added to the text as well.

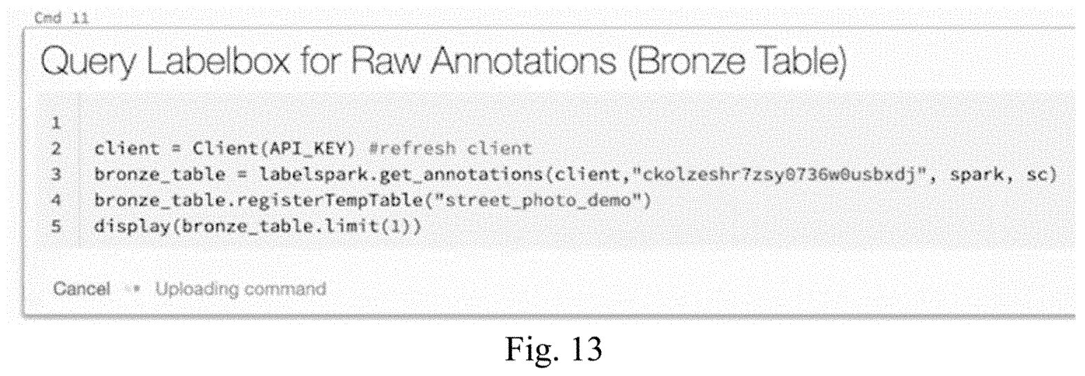

Referring to FIG. 13, once the data set has been labeled, the user can pull the data set into the compute and analytics environment by calling the get annotations method provided by an example embodiment.

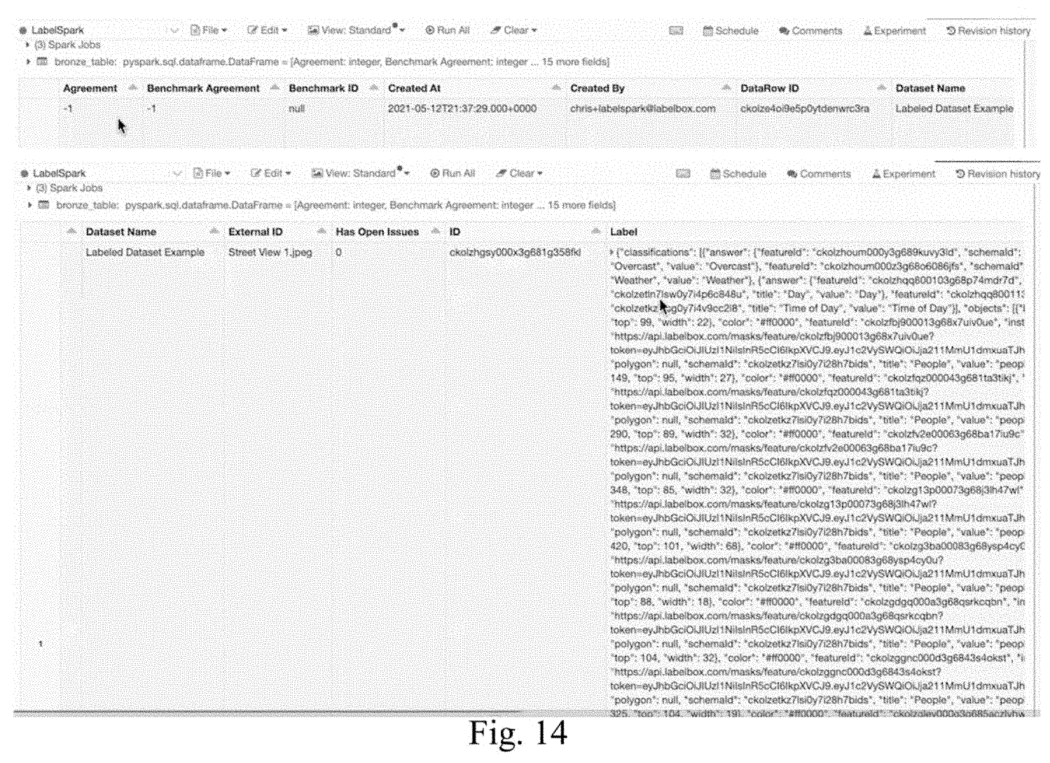

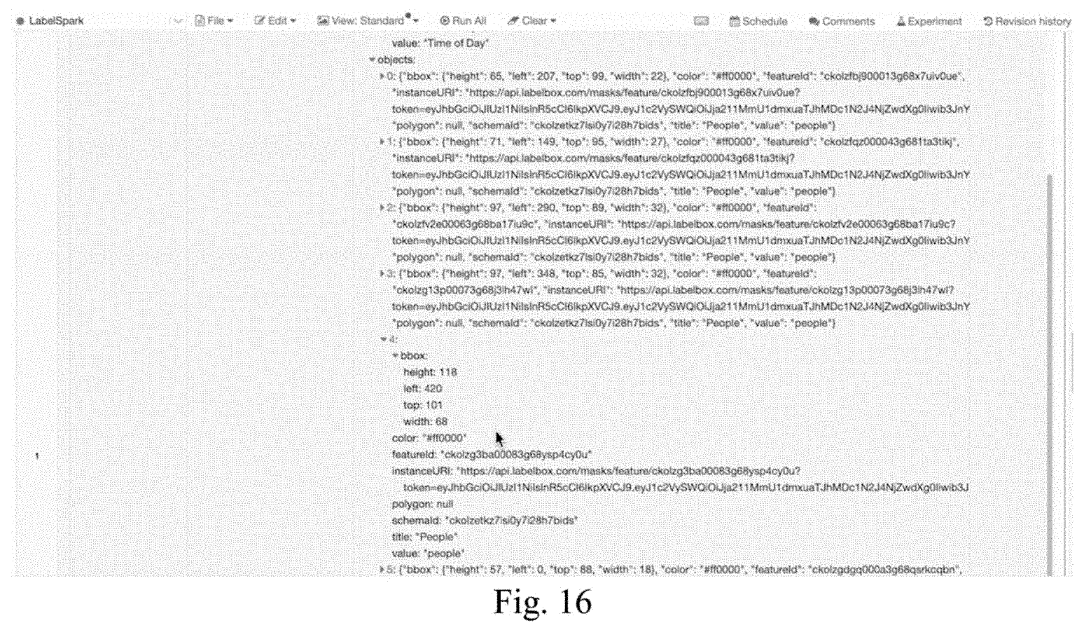

Referring to FIGS. 14 through 18, once the labeled data set is pulled into the compute and analytics environment, we can take a look at the first row of the example so we can get an idea of what the Training Data Platform (e.g., Labelbox, Inc.) returns. The returned data can include some metadata columns. These are useful if you are using some of the more advanced feature in Training Data Platform (e.g., Labelbox, Inc.) like consensus where you might want multiple people to label the same image in case there is some subjectivity on how to label it. You can actually average their responses and score different data rows based on the consensus. The returned data can also include some information about who created this label, the data set that it belongs to, and the file name, (e.g., “Street View 1.jpeg”), etc. The returned data from the Training Data Platform (e.g., Labelbox, Inc.) can also include an issues and comments column where if something is identified as wrong in this labeled image, it can be flagged as an issue. The returned data can also include a label column. This is a valuable column as it includes the annotations for this particular image. The Training Data Platform (e.g., Labelbox, Inc.) delivers the label data as JSON. JSON is an open standard file format and data interchange format that uses human-readable text to store and transmit data objects consisting of attribute-value pairs and arrays. This provides an open standard so the user is not locked into annotations in some proprietary format. The Training Data Platform (e.g., Labelbox, Inc.) delivers the label data as JSON so the user can parse the data as needed.

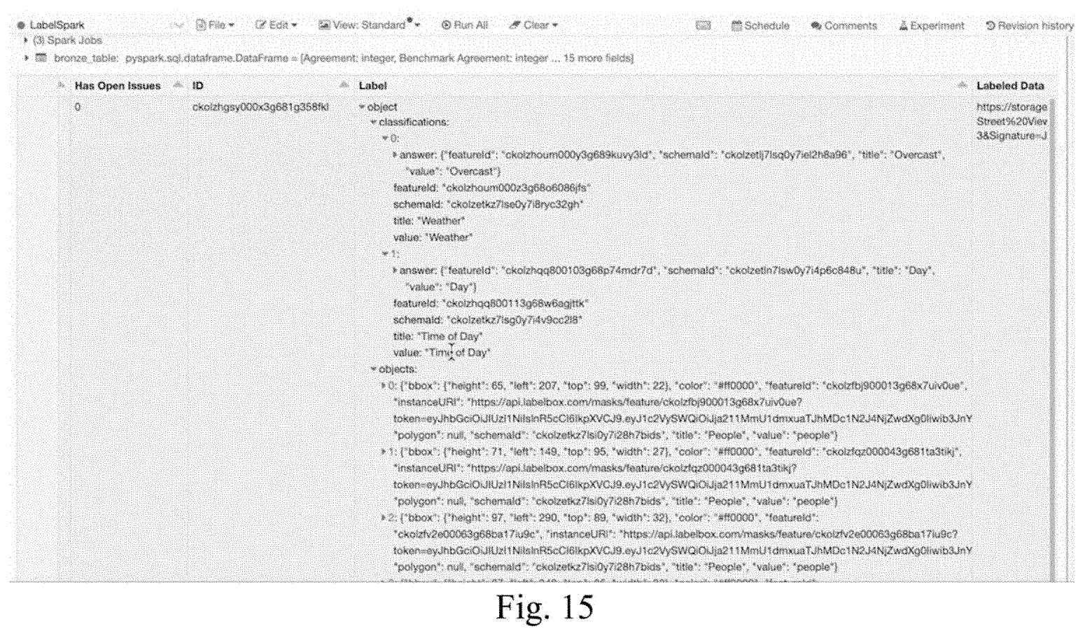

Referring to FIG. 15, we can pull apart the JSON data for the example image. In the example, we have a couple of classifications for this sample image, such as it's an overcast weather image shot during the day and we have a handful of objects. For example, it looks like the image has some bounding boxes mostly, so lots of people were identified in the image. If we open up one of the bounding boxes within this spark data frame, we can observe that the Training Data Platform (e.g., Labelbox, Inc.) includes the x and y coordinates of that bounding box as well as some information like the height and the width. So this data is already very useful to data scientists who can process this JSON data. But, the Training Data Platform (e.g., Labelbox, Inc.) also includes a couple of methods that help make this information a little bit more digestible.

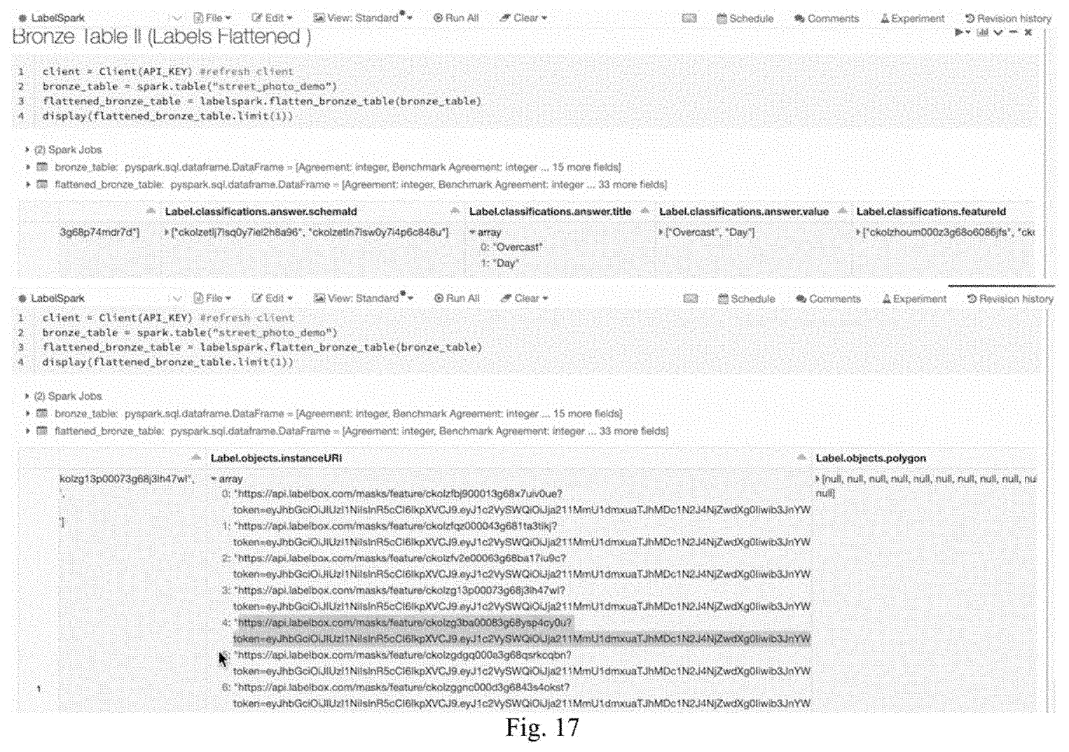

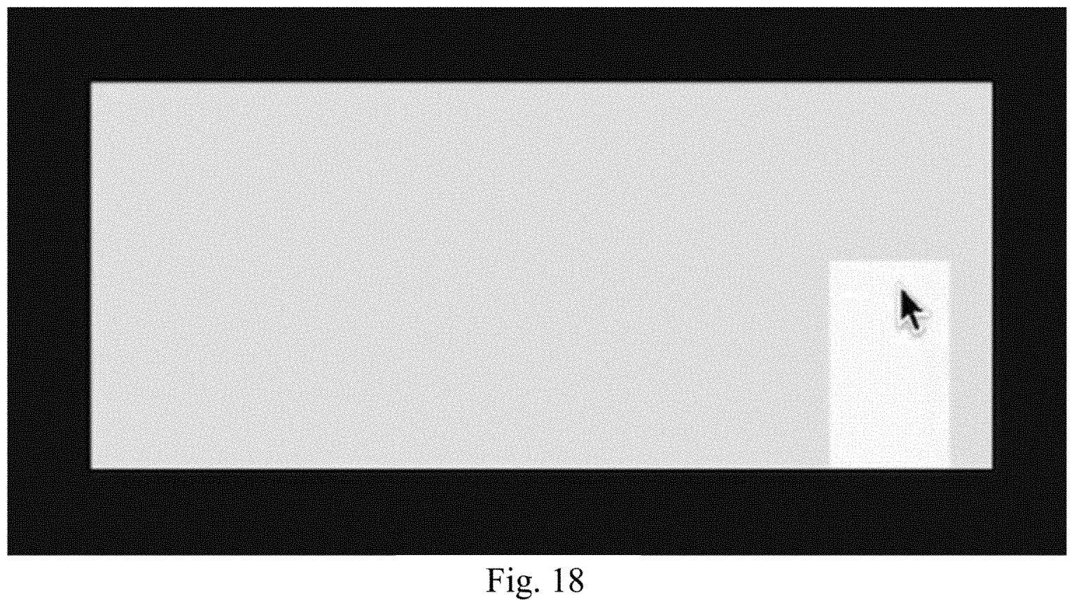

Referring to FIG. 17, we're going to run our table flattener to basically pull apart that JSON into separate columns. Some of these columns are a little less useful, but they're more for developers who want to keep track of identifying pieces of information within the Training Data Platform (e.g., Labelbox, Inc.) API. But we also get here the array of classification responses or the array of objects in the frame. The JSON also includes a list of all of the masks that apply to the objects in the example image frame. If one of these masks of the example is chosen, an image file (e.g., a PNG file) with the mask over that object is displayed as shown in FIG. 18. This mask is the file that a user can use with machine learning to identify where in an image certain objects occur. You can use this with segmentation masks, for example, to teach machine learning how to recognize specific objects at a pixel perfect level or you can use bounding boxes like the example shown.

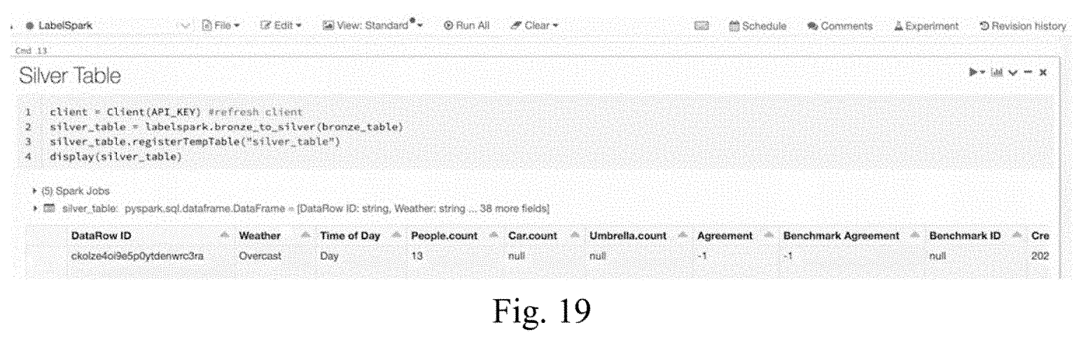

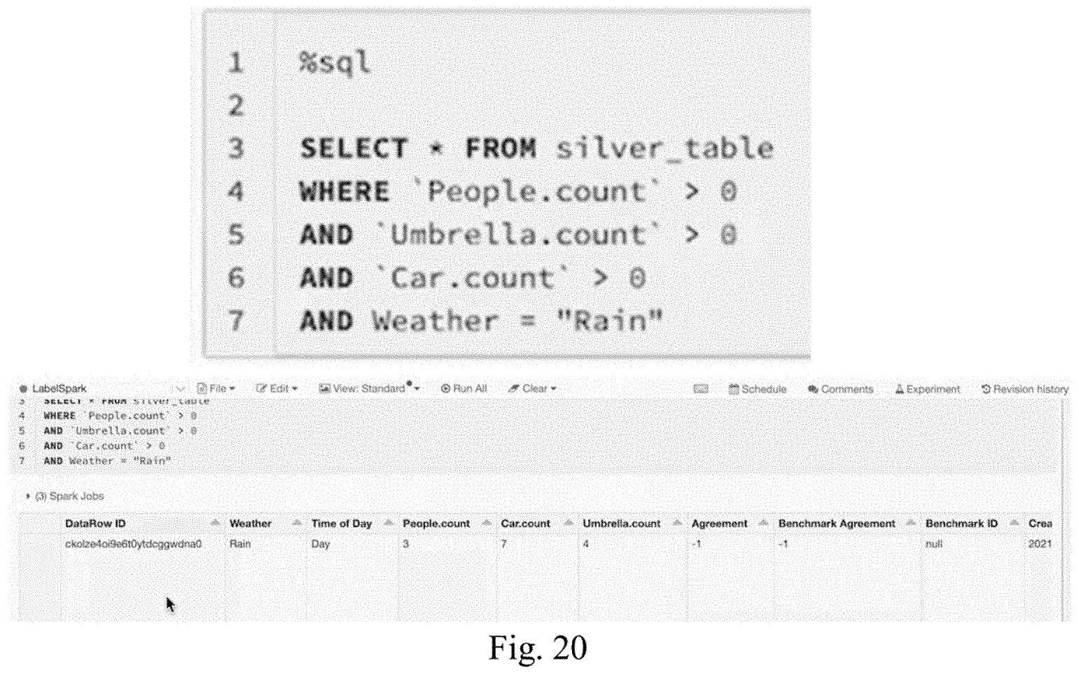

Referring to FIG. 19, the returned data from the Training Data Platform (e.g., Labelbox, Inc.) can also include a weather column, time of day, as well as the people, car, and umbrella count of the example. So, if a user is interested in finding all of the images of a specific weather type, or day, or maybe you're only concerned about people, a user can actually start to write queries against this table and filter down by those specific data rows. For an example and referring to FIG. 20, a user can run a query to find all of the photos that have people, cars, umbrellas, and also rain. In the example shown in FIG. 20, this SQL query returned one image from the entire data set where all of the specified conditions are satisfied.

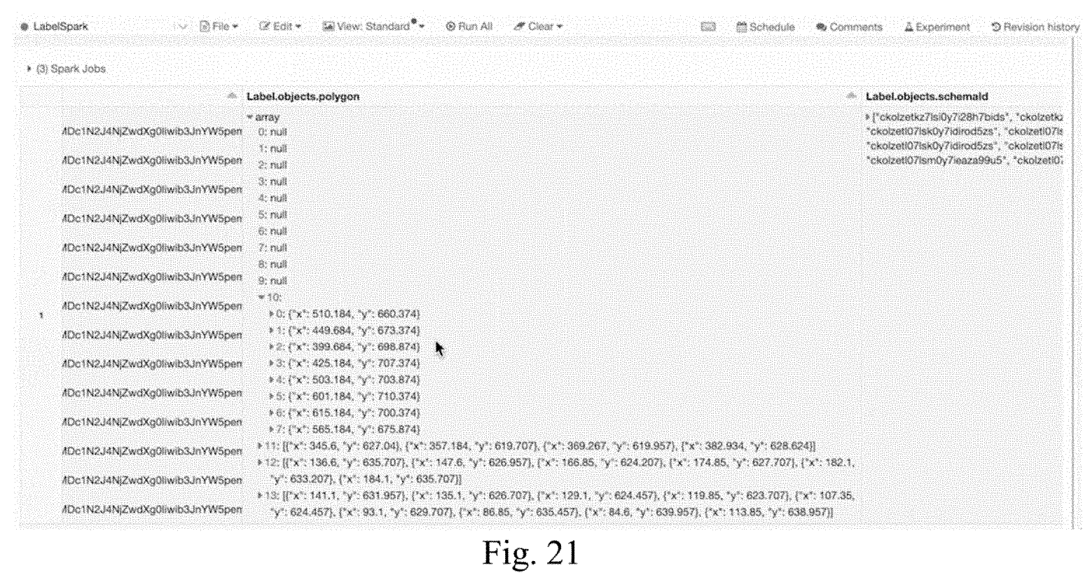

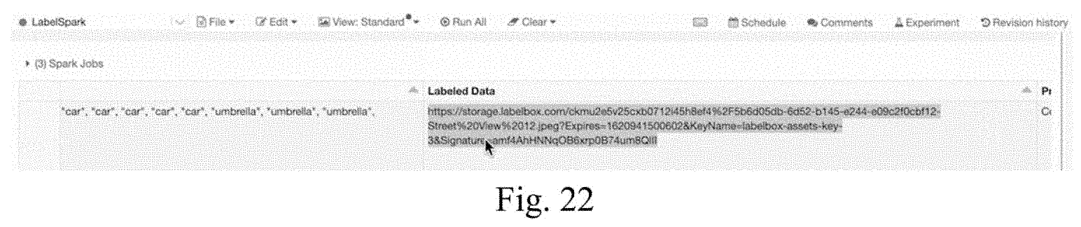

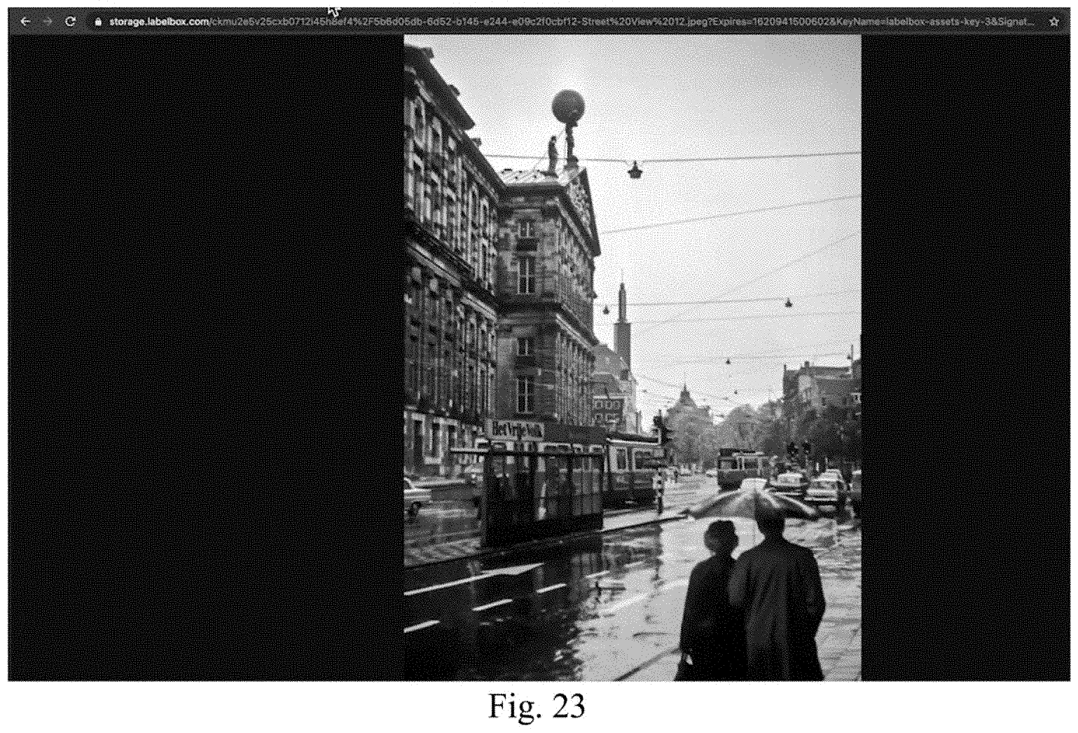

Given the data for the matching image, the columns for the matching image can provide information on the objects from the image (see FIG. 21). Earlier we had seen an example of a data row with all people. This example actually has some umbrellas in it so you get the x and the y coordinates of the polygons for each of those umbrellas. Additionally, a user may want to quickly visualize it. Referring to FIG. 22, a user can take the provided link and follow it back to that original asset to view the image as shown in FIG. 23.

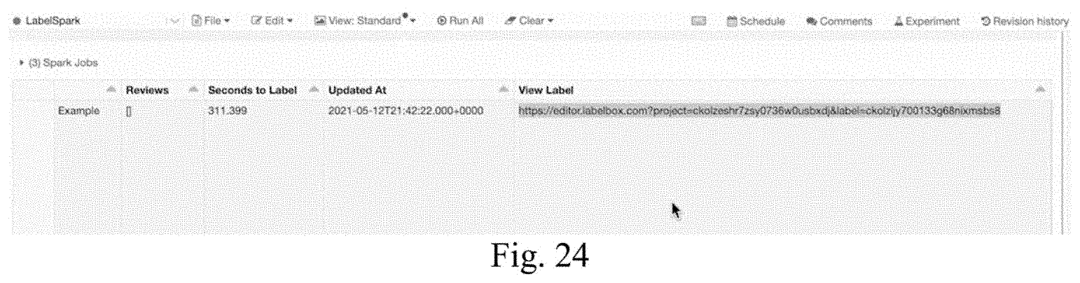

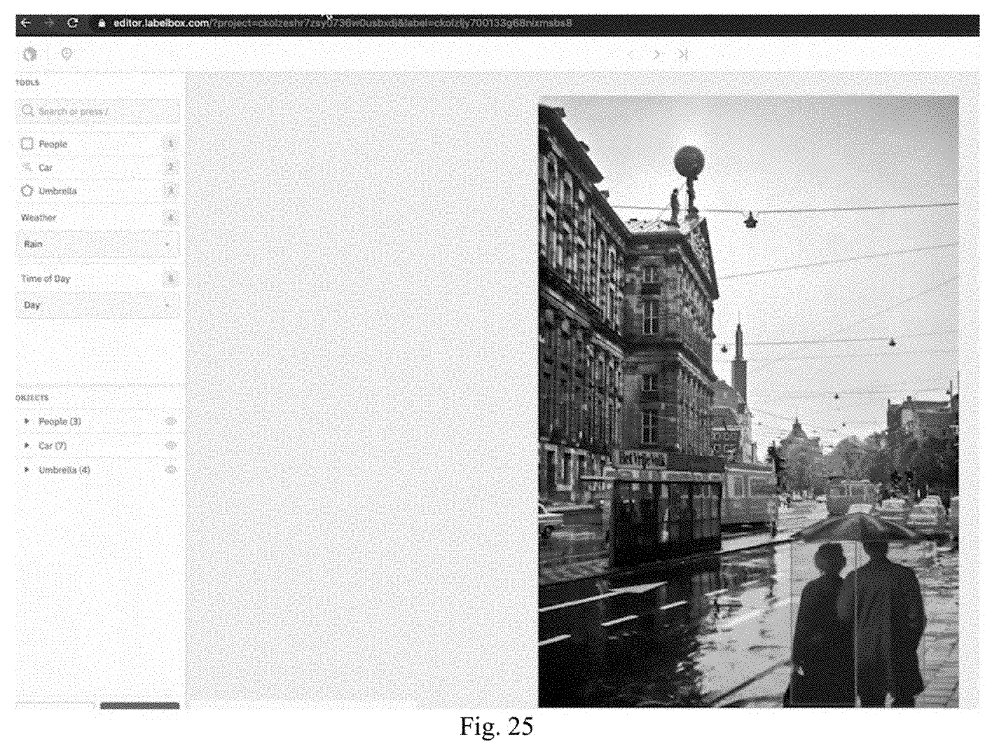

Referring to FIG. 24, in the provided column, a user can get a link back to that label in the Training Data Platform (e.g., Labelbox, Inc.) that loads all of the bounding boxes, segmentation masks, polygons, and classifications that were on that image frame as shown in FIG. 25.

Thus, the tools provided by the example embodiments described herein allow a user to write a query and to quickly jump into image data resulting from the query and look at exactly how the image was labeled.

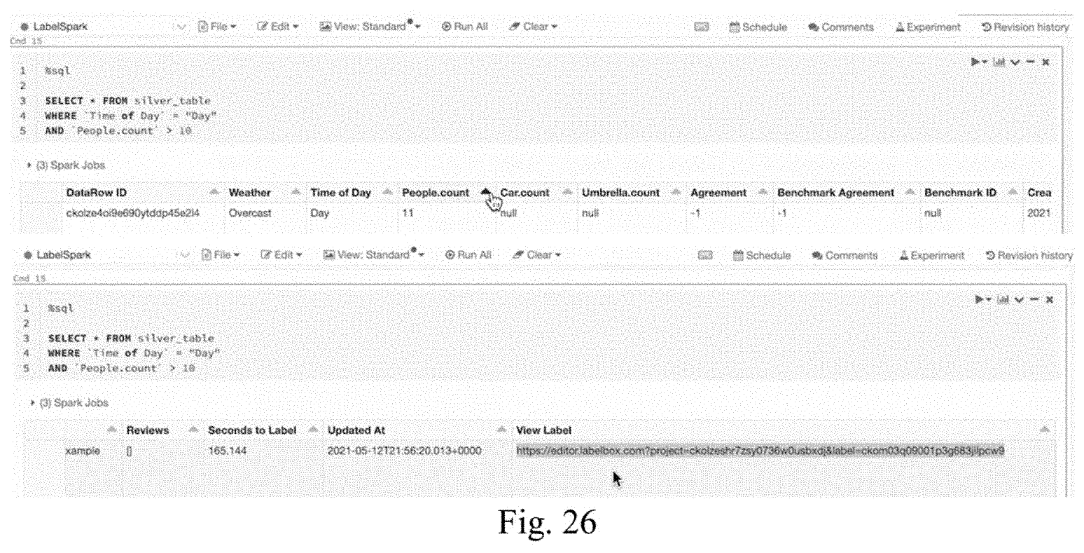

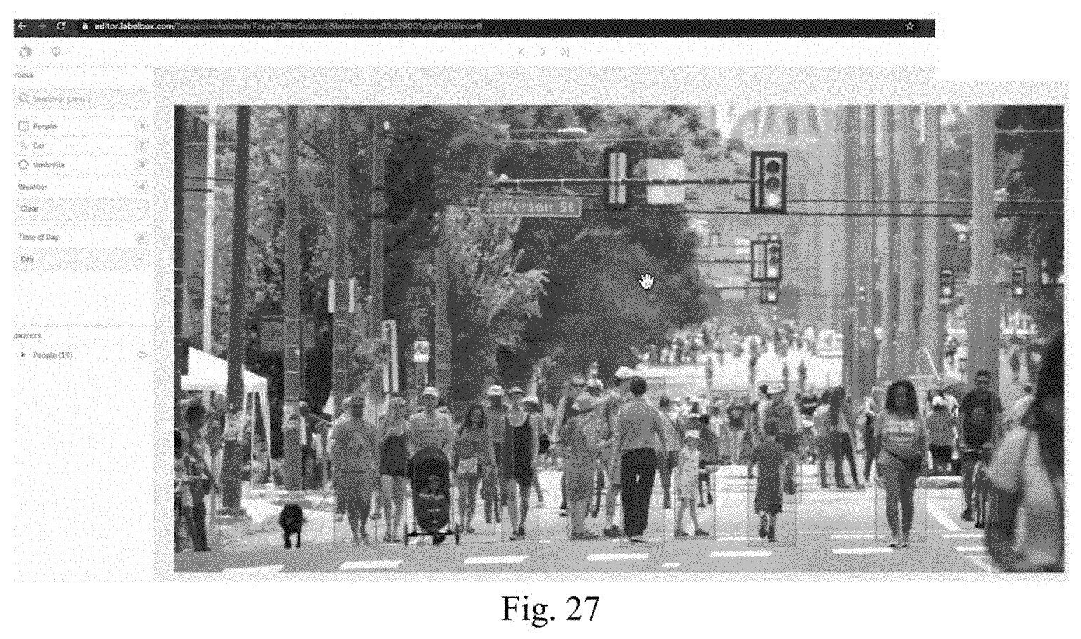

In another example, refer to FIGS. 26 and 27. In this example, a user can write another query and choose results with time of day=daytime and wherever we have more than 10 people in the image. The example embodiment returns results including a link to the labeled image shown in FIG. 27. So, the tools provided by the example embodiments described herein provide a very easy way to query previously unstructured data sets and dive in and inspect them. These tools can also be used to power some machine learning workflows. As described in the examples below, we actually train a model to recognize people, umbrellas, and cars (for example) and use the trained model to label an example image that we have never seen before.

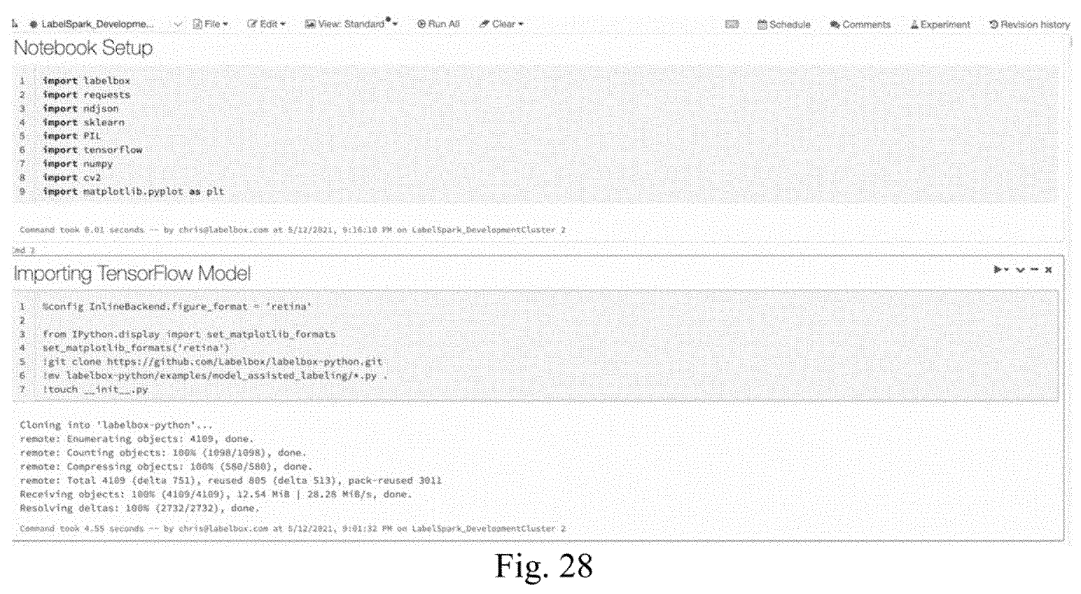

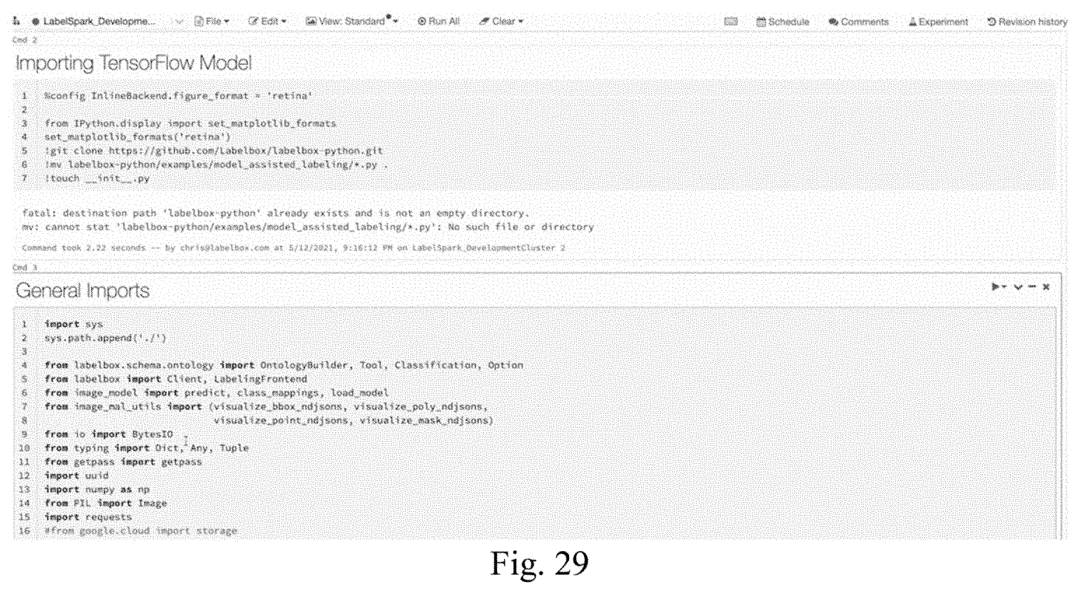

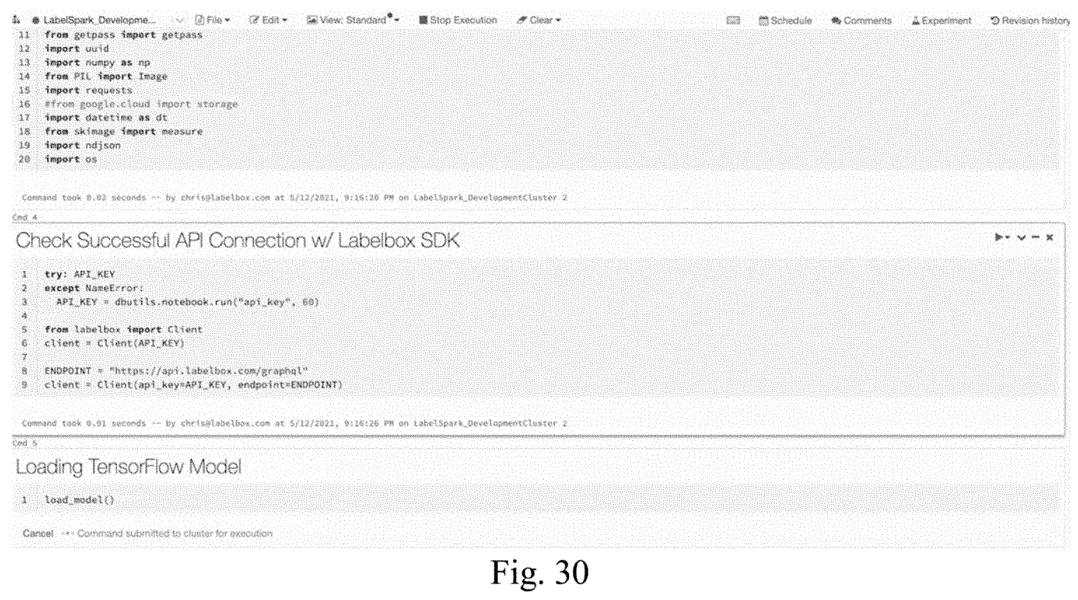

Referring to FIGS. 28 through 30, an example illustrates the use of the trained model to label an example image that we have never seen before. As shown in FIG. 28, a data bricks notebook shows some code and the import of a TensorFlow model trained on the training data from the example described above with an image of people, cars, and umbrellas. The trained model can take in a new unstructured piece of data and use this TensorFlow model (or other trainable model) to label the new unstructured piece of data. The trained model could be any model. This is the user's model environment. That's an important feature of the training data platform, wherein the user's model is the one that's automatically learning and importing this new data for further learning so the model is always being revised and improved.

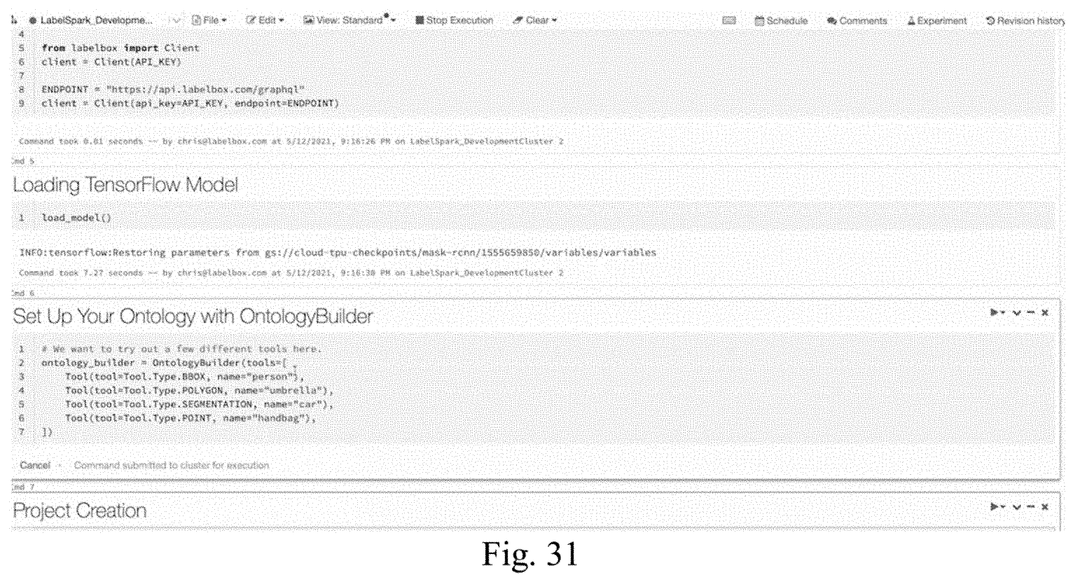

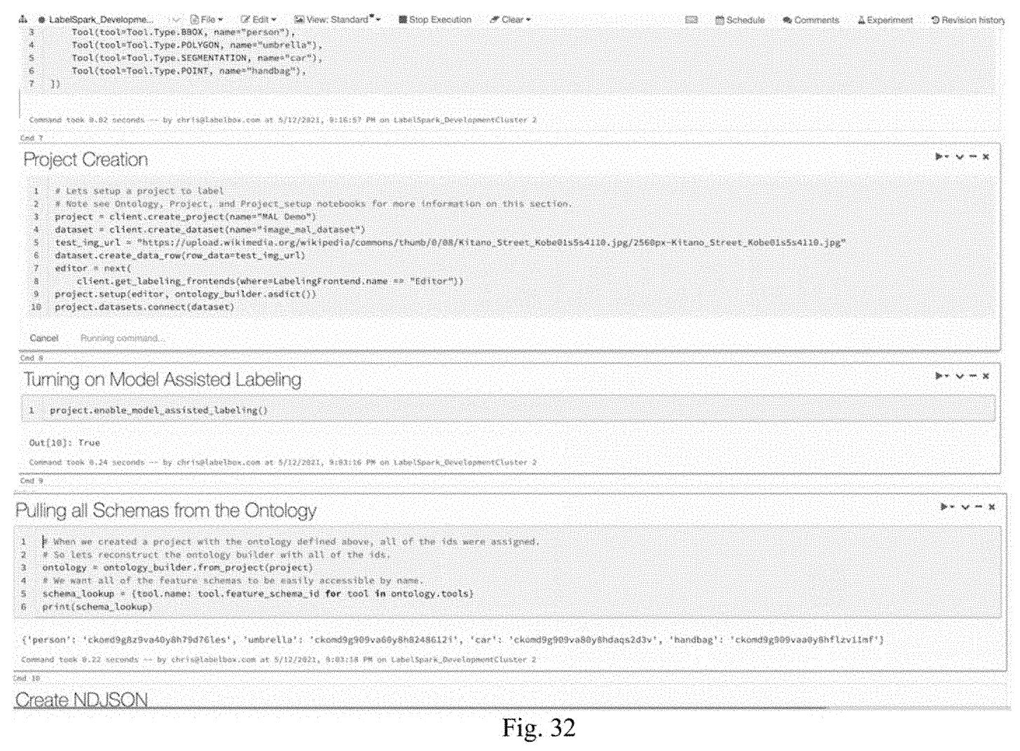

Referring to FIGS. 31 and 32, once the model is loaded, we'll go in and use this ontology builder again to build the same ontology as the example described above; except, we're including a handbag object this time to show the point tool. We can create our project with a new piece of data that includes people, cars, and any other objects or classifications we want to target in the structuring of the data. In the example shown in FIGS. 28 through 30, a project is created with this a piece of data called MAL Demo and with Model assisted labeling activated.

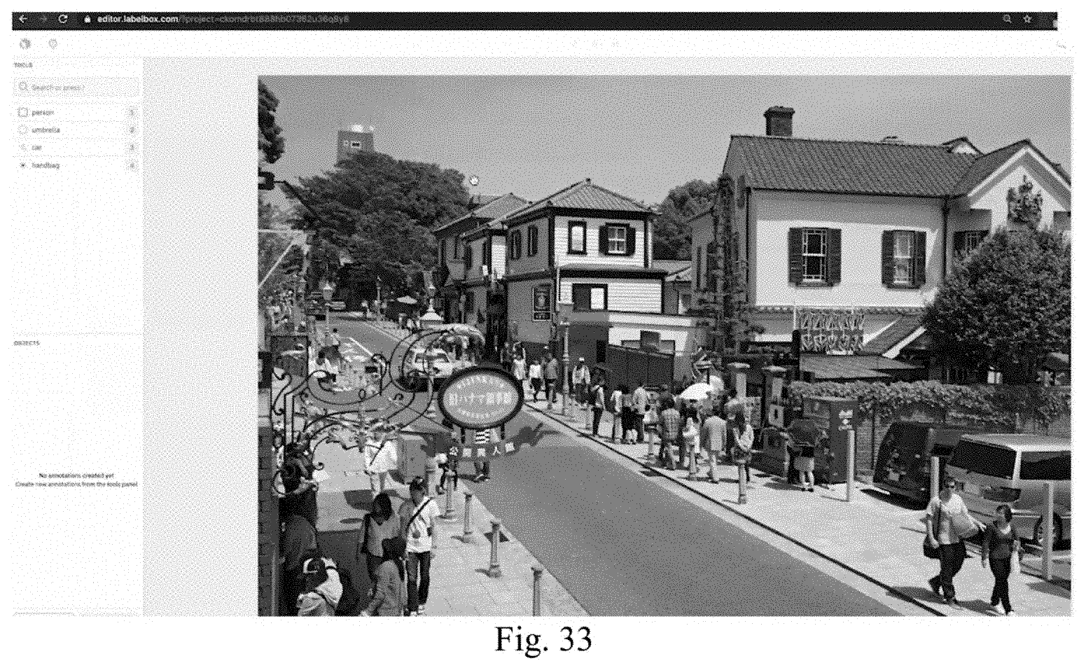

As shown in the sample image of FIG. 33, there are a lot of people, cars, and umbrellas in the sample image. It would be a really tedious job to manually label the image with bounding boxes on objects in this sample image. As an alternative, we can include this data in the training data used to train the TensorFlow Model.

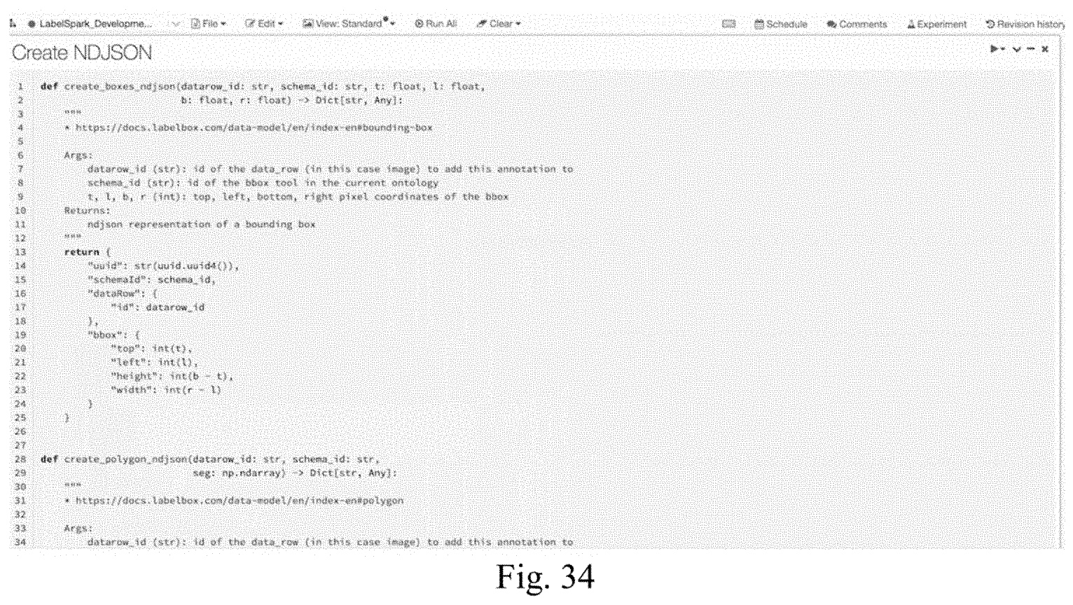

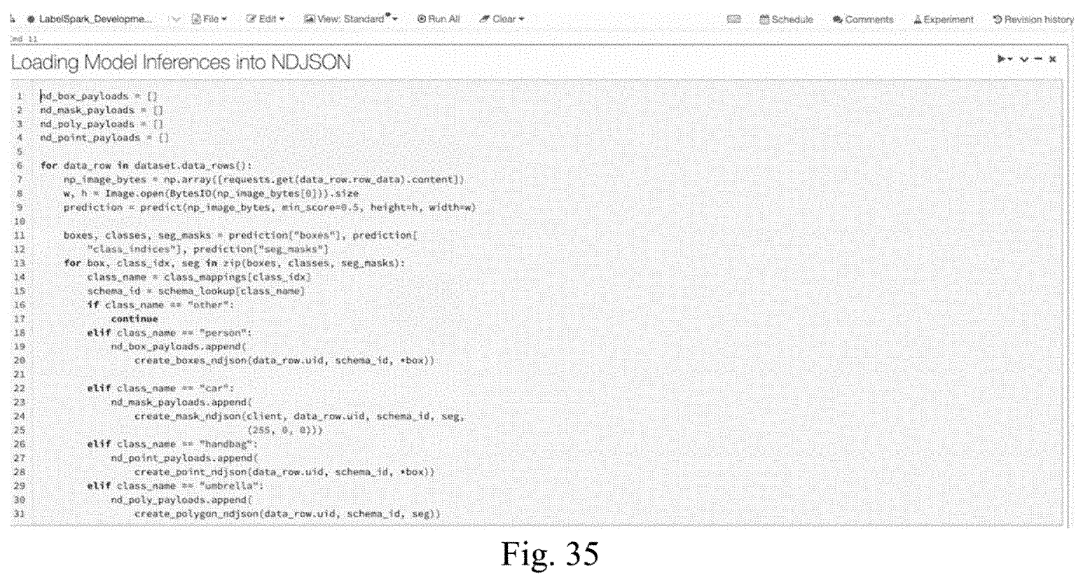

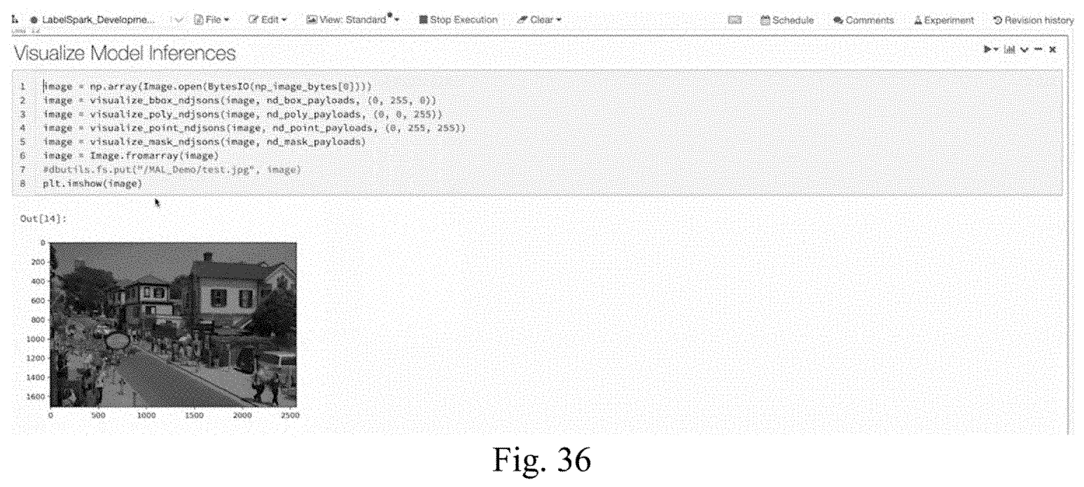

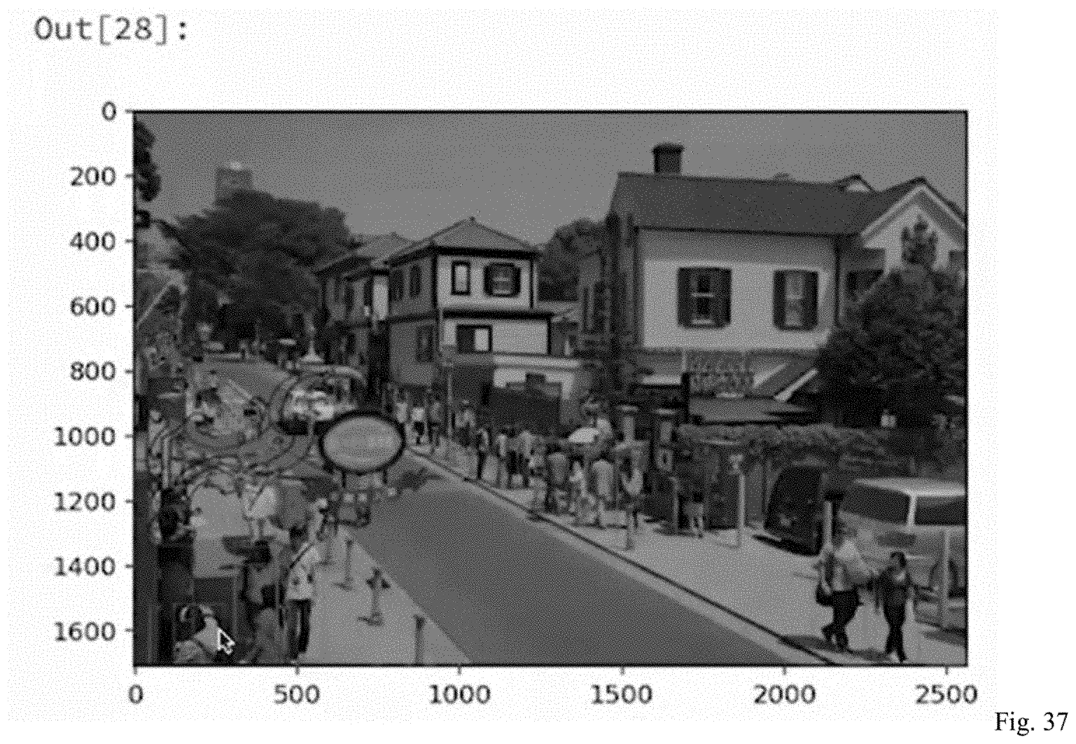

Referring to FIGS. 34 through 36, an ontology is created with related schemas; so, my model can relate to the schemas. We can put all of these schemas in NDJSON (see FIGS. 34 and 35), which is basically going to take in our model inferences and map them to a label boxified version. Then, we can load all those inferences into the Training Data Platform (e.g., Labelbox, Inc.) ready JSON. The visualisation of the unstructured model is shown in FIG. 33. The structured model output in this example is shown in FIGS. 36 and 37. The model output includes the bounding boxes around the type of objects defined in the ontology as described above. In particular, the example shown in FIG. 37 shows bounding boxes around the handbags, cars, people, and umbrellas in the image. This labeling data is automatically created by the trained model.

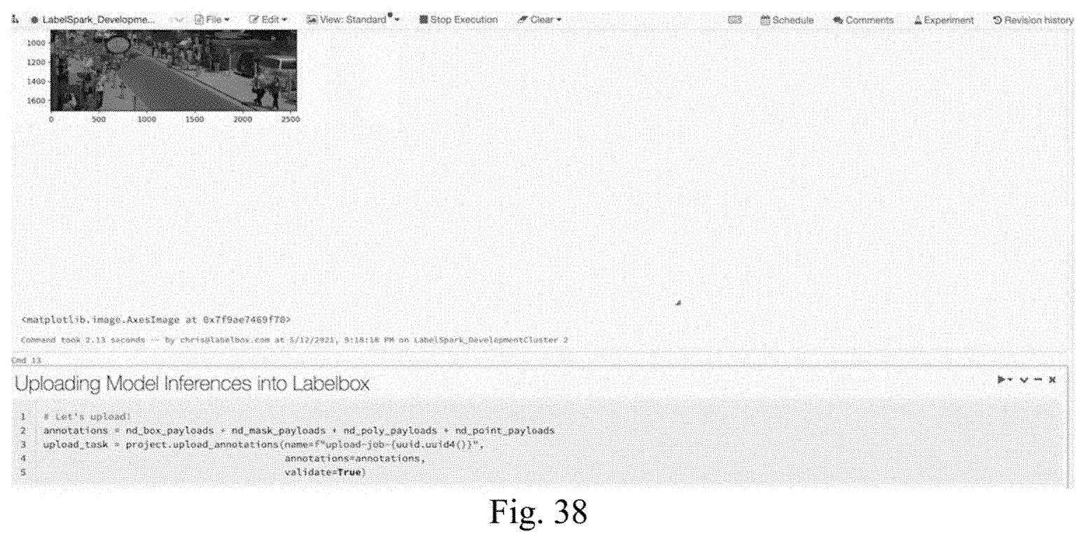

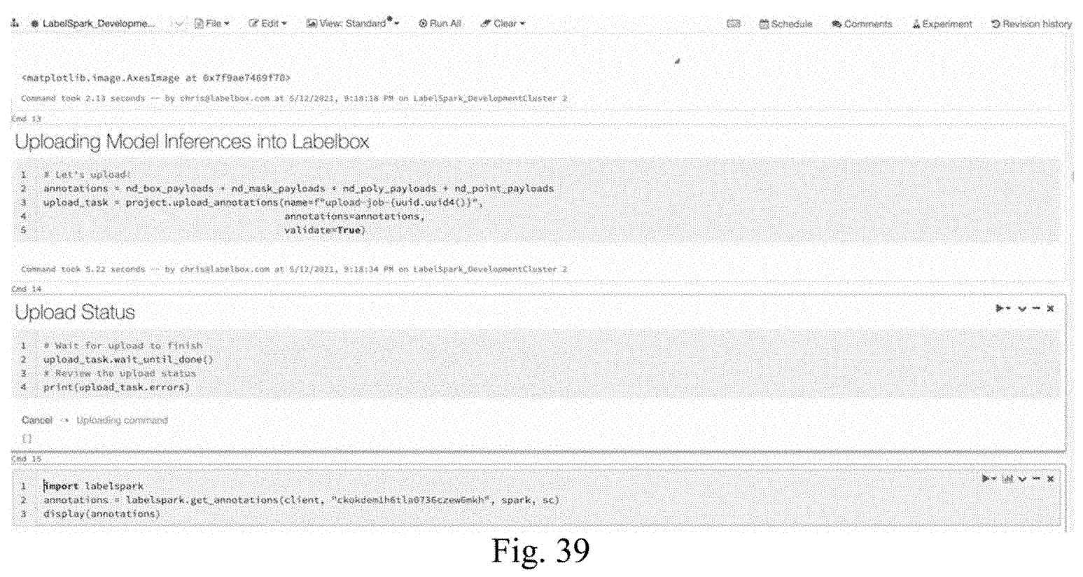

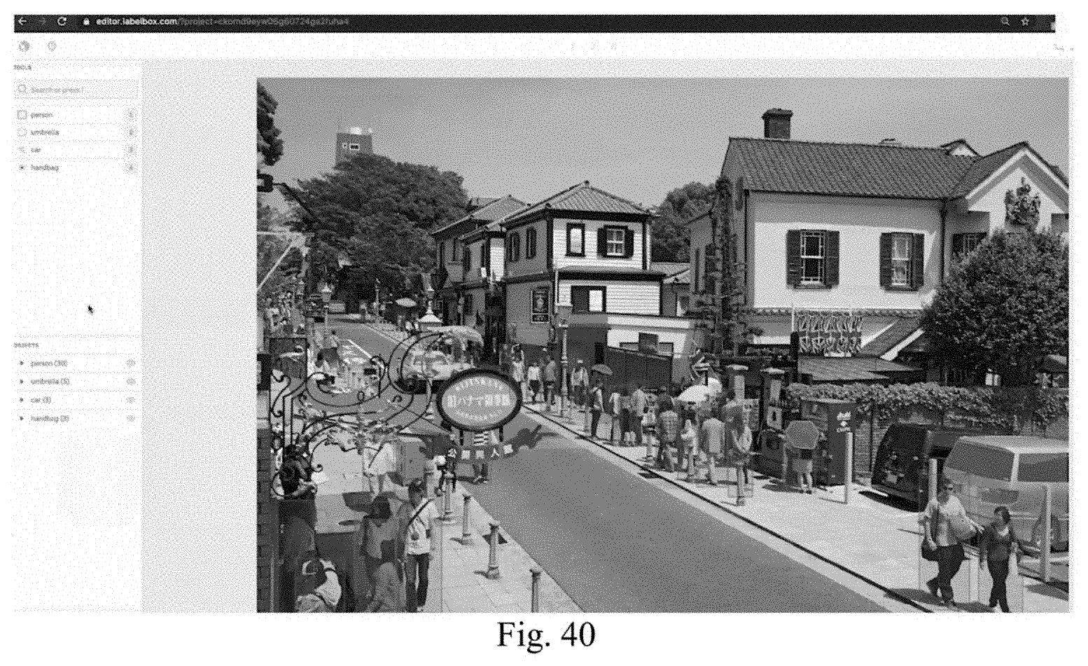

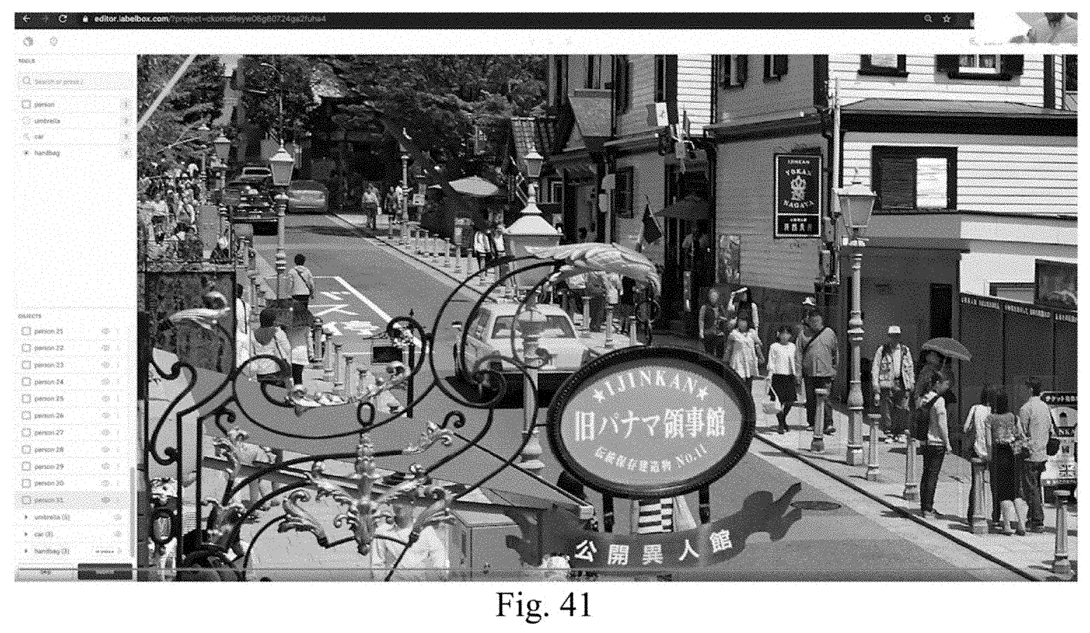

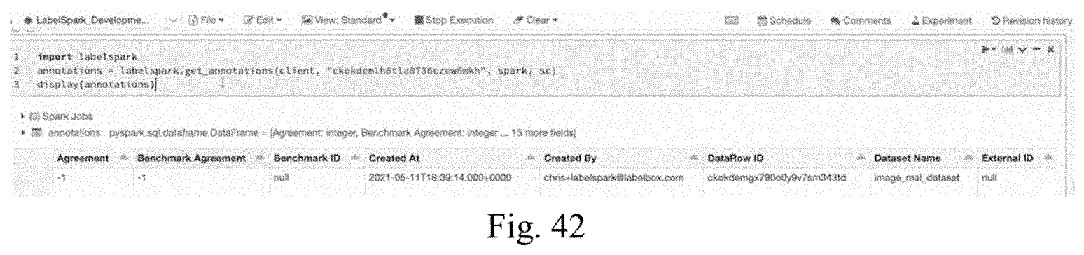

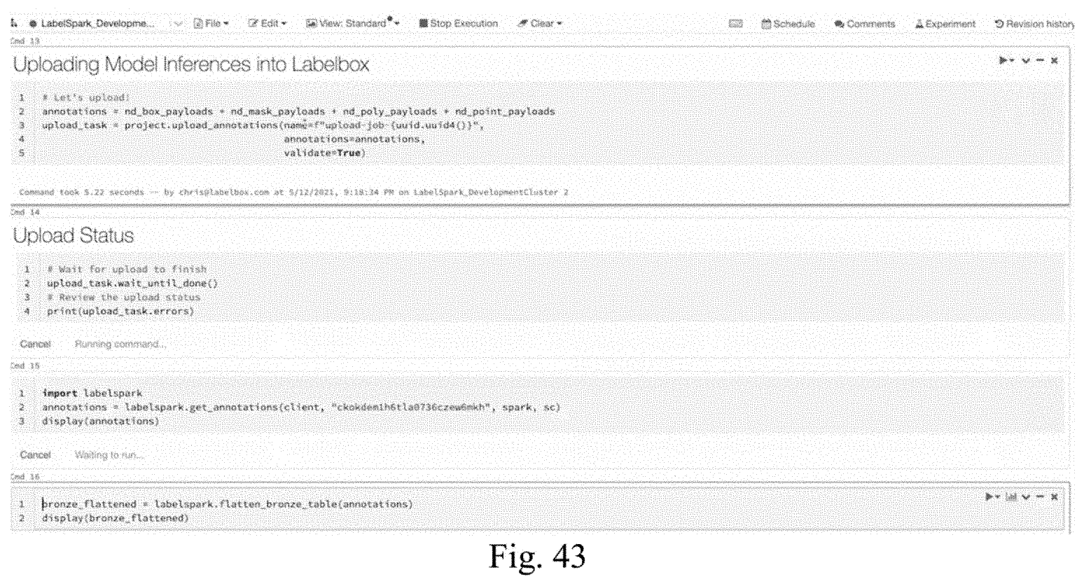

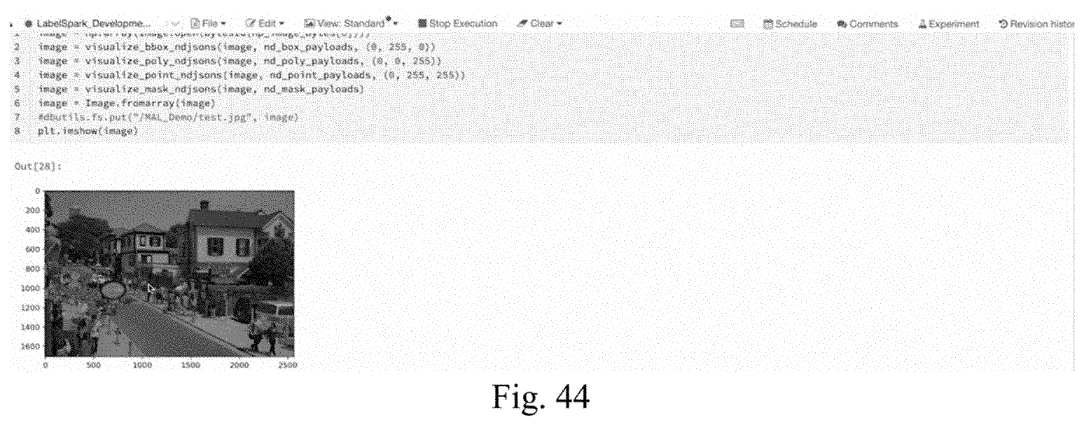

In a next step shown in FIGS. 38 and 39, the labeling data created by the trained model can be uploaded into the Training Data Platform (e.g., Labelbox, Inc.). As shown in FIGS. 38 and 39, model inferences can be uploaded from NDJSON into the Training Data Platform (e.g., Labelbox, Inc.). A visualization of the model inferences in the Training Data Platform (e.g., Labelbox, Inc.) is shown in FIG. 40. A user can then use the Training Data Platform (e.g., Labelbox, Inc.) to further refine or modify the label data created by the model. The model inferences uploaded to the Training Data Platform (e.g., Labelbox, Inc.) enable the output of the model to be used as training data. As described above, it would be really difficult to go in and label all of the objects in the sample image. But, now the uploaded model inferences provide pre-labeled objects. Using the Training Data Platform (e.g., Labelbox, Inc.) as a labeler, a user can further train the model on the edge cases. For example as shown in FIG. 41, a labeler can zoom in to label an umbrella missed by the model or adjust a bounding box that captured a few too many people. As such, the labeler can use the Training Data Platform (e.g., Labelbox, Inc.) to adjust or modify the model inferences to improve the model with this new training data. As shown in FIGS. 42 through 44, all of the modifications to the annotations produced by the labeler in the Training Data Platform (e.g., Labelbox, Inc.) as described above can be retained and used in a next iteration to further improve the inferences produced by the model. This solution provides an iterative active workflow to continually improve model output.

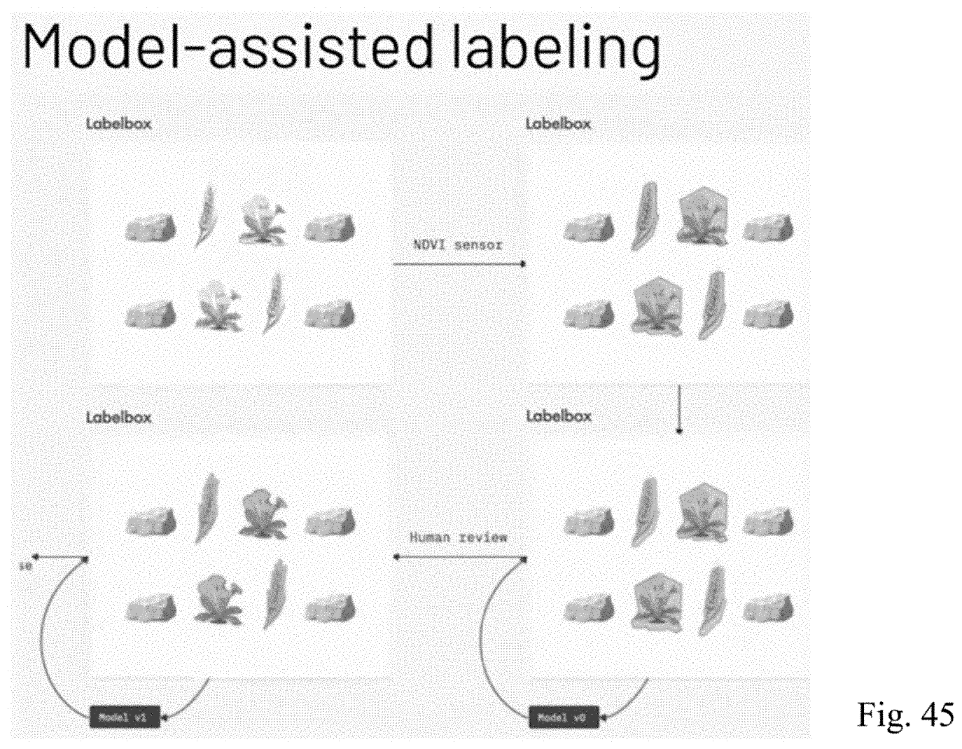

As described above and summarized in FIG. 45, the example embodiments illustrate an example of a model assisted labeling workflow where unstructured data can be labeled or annotated, and then a trained model can be produced. Next, the trained model can be used to pre-label an asset or data set that the model had never seen before. After that, the automatic pre-labeling produced by the model can be uploaded to the Training Data Platform (e.g., Labelbox, Inc.) where a labeler can revise, modify, or correct the model output. Finally, the revised annotations produced by the labeler in the Training Data Platform (e.g., Labelbox, Inc.) can be used in another iteration to further train and improve the model. As a result, the model can be continually trained using automated workflows.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An automated content labeling and model training system comprising:
a data processor; and
an automated content labeling and model training platform, executable by the data processor, the automated content labeling and model training platform being configured to:
receive an unstructured data set in a compute and analytics environment;
provide an interface to a training data platform to pass the unstructured data set to the training data platform for labeling;
use the training data platform to label the unstructured data set to produce an annotated structured data set;
transfer the annotated structured data set to the compute and analytics environment;
use the annotated structured data set to train a machine learning model;
use the trained machine learning model to produce a second annotated structured data set;
transfer the second annotated structured data set to the training data platform for label modification; and
use the modified second annotated structured data set to further train the machine learning model.

2. The automated content labeling and model training system of claim 1 wherein the automated content labeling and model training platform being further configured to pass the unstructured data to the training data platform where a team of labelers and subject matter experts add structure and enrich the unstructured data with annotations.

3. The automated content labeling and model training system of claim 1 wherein the automated content labeling and model training platform being further configured to pass the unstructured data to the machine learning model, which is configured to pre-label data going into the training data platform.

4. The automated content labeling and model training system of claim 1 wherein the automated content labeling and model training platform being further configured to enable a human labeler to audit the machine learning model to determine how the labeling process performs.

5. The automated content labeling and model training system of claim 1 wherein the unstructured data set is image data.

6. The automated content labeling and model training system of claim 1 wherein the automated content labeling and model training platform being further configured to provide an ontology builder that allows a user to programmatically set up an ontology for the unstructured data set.

7. The automated content labeling and model training system of claim 1 wherein the automated content labeling and model training platform being further configured to provide a polygon tool to assist a labeler in labeling objects in an image.

8. The automated content labeling and model training system of claim 1 wherein the automated content labeling and model training platform being further configured to provide a bounding box tool to assist a labeler in labeling objects in an image.

9. The automated content labeling and model training system of claim 1 wherein the automated content labeling and model training platform being further configured to interpolate over a plurality of frames of a video.

10. The automated content labeling and model training system of claim 1 wherein the automated content labeling and model training platform being further configured to provide a consensus feature where multiple to label a same image.

11. The automated content labeling and model training system of claim 1 wherein the annotated structured data set is a JavaScript Object Notation (JSON).

12. The automated content labeling and model training system of claim 11 wherein the automated content labeling and model training platform being further configured to provide a table flattener to dissect the JSON into separate columns.

13. The automated content labeling and model training system of claim 11 wherein the JSON includes a list of masks that apply to objects in the unstructured data set.

14. The automated content labeling and model training system of claim 1 wherein the automated content labeling and model training platform being further configured to use the trained machine learning model to label a new unstructured data set.

15. The automated content labeling and model training system of claim 1 wherein the automated content labeling and model training platform being further configured to upload model inferences to the training data platform.

16. A method comprising:
receiving an unstructured data set in a compute and analytics environment;
providing an interface to a training data platform to pass the unstructured data set to the training data platform for labeling;
using the training data platform to label the unstructured data set to produce an annotated structured data set;
transferring the annotated structured data set to the compute and analytics environment;
using the annotated structured data set to train a machine learning model;
using the trained machine learning model to produce a second annotated structured data set;
transferring the second annotated structured data set to the training data platform for label modification; and
using the modified second annotated structured data set to further train the machine learning model.

17. The method of claim 16 including passing the unstructured data to the training data platform where a team of labelers and subject matter experts add structure and enrich the unstructured data with annotations.

18. The method of claim 16 including passing the unstructured data to the machine learning model, which is configured to pre-label data going into the training data platform.

19. The method of claim 16 wherein the annotated structured data set is a JavaScript Object Notation (JSON).

20. The method of claim 16 wherein the unstructured data set is image data.
